(19) United States
(12) Patent Application Publication
(10) Pub. No.: US 2006/0284951 A1
(43) Pub. Date: Dec. 21, 2006

(54) Process and apparatus for forming pattern

(75) Inventors: Hiroshi Ikeda, Kanagawa (JP); Ken Hashimoto, Kanagawa (JP); Masahiko Fujii, Kanagawa (JP); Jun Isozaki, Kanagawa (JP); Koichi Saitoh, Kanagawa (JP); Naosuke Ino, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/444,018

(22) Filed: May 31, 2006

(30) Foreign Application Priority Data
Jun. 17, 2005 (JP) 2005-178276
Dec. 26, 2005 (JP) 2005-373004
Dec. 26, 2005 (JP) 2005-373281

(51) Int. Cl. B41J 2/01

(52) U.S. Cl. 347/103

(57) ABSTRACT

The invention presents a pattern forming apparatus including: an intermediate transfer body; a particle supply unit, for forming a liquid receptive particle layer of a specified layer thickness by supplying liquid receptive particles, capable of receiving a recording liquid containing recording material and also capable of trapping the recording material at the surface thereof, onto the intermediate transfer body; a liquid droplet ejection unit for ejecting liquid droplets of the recording liquid on the liquid receptive particle layer on the basis of specified data, and forming a pattern of the recording material near the surface of the liquid receptive particle layer; and a transferring unit, for transferring the liquid receptive particle layer containing the recording liquid onto a transfer object, so that the pattern is placed between the transfer object (recording medium) and the liquid receptive particle layer.

### CROSS-REFERENCE TO RELATED APPLICATION

This application and claims priority under 35 USC 119 from Japanese Patent Application Nos. 2005-178276, 2005-373281, and 2005-373004, the disclosures of which are incorporated by reference herein.

### BACKGROUND OF THE INVENTION

1. Field of the Invention

The present invention relates to a pattern forming method and a pattern forming apparatus using a liquid droplet ejection system, and more particularly to a pattern forming method and a pattern forming apparatus using an intermediate transfer type recording system for recording a pattern by liquid droplets on the surface of an intermediate transfer body, then transferring the pattern onto a transfer object, and forming the pattern on the surface of the transfer object.

2. Description of the Related Art

Hitherto, the image forming apparatus of ink jet recording systems had various problems, such as change in printing state depending on difference in recording medium (for example, difference in manner of permeation of ink), and distortion of undried portions of images when discharging the recording medium or when inverting, in the case of double-sided printing, when a recording medium not allowing ink permeation is used.

In image forming by ink jet, ink is directly injected onto the recording medium depending on an image signal, and characters or an image is formed. Recently, owing to enhancement in image forming speed, an FWA (Full Width Array) recording apparatus, having nozzles disposed in the overall width of recording medium to be conveyed, is needed.

In such a FWA type of recording device, the time required for discharging the recording medium on which characters, images or the like have been formed becomes shorter, and the time taken for drying ink permeated into the recording medium becomes shorter, when compared to conventional scanning type recording devices. Because of this, there is a fear that deterioration of images will be generated when the surface is rubbed or is pressed by rollers or the like just after printing as ink on the printed surface has not been sufficiently fixed. Especially when undertaking double sided recording, because a certain period of drying time is required in order that the above deterioration in images does not occur, productivity decreases.

For this type of problem, in order to promote evaporation of solvents contained in inks on impermeable papers, in particular, if a drying unit such as heater is installed in the apparatus, a large amount of energy is needed for drying, and the apparatus needs to be increased in size.

In inks containing pigment, water-soluble polymers may be added to the ink in order to improve dispersion of pigment and increase the fixing strength. In particular for fixing pigments on impermeable papers, if it is desired to have enough image fastness such as rubbing resistance, more water-soluble polymers must be added. However, if the addition amount of water-soluble polymers is increased, injection may be unstable or not possible due to thickening or solidifying in the nozzles, and a serious problem in the reliability may occur.

In conventional inkjet recording devices, in order to get around the above problem, special recording media such as special papers for inkjet have been used, which have a coating layer of a porous, ink absorbing material such as inorganic pigments formed on the recording medium. Use of such special recording media enable ink to permeate rapidly, and an image in a region having a undried ink image to avoid the problem due to distortion when the recording media is discharged, or when an inverting operation is carried out in double-sided printing. Further, images with high density and high quality can be obtained at high speed, without bleeding or the like.

However, high quality/high speed printing cannot be carried out under such a limited use of the special recording medium, and therefore a usable recording medium is limited.

As an intermediate transfer type ink jet recording method using water-based ink, an ink jet recording method for improving the wettability by pre-applying a surfactant on the intermediate body has been proposed (see, for example, Japanese Patent Application Laid-Open (JP-A) No. 07-89067).

In this example, both image forming performance on the intermediate body, and transfer performance from the intermediate body to the recording medium are satisfied. This example is a method of evaporating water by heating, and it takes a long time until ink viscosity is increased. Besides, since moisture is not completely removed by heating and evaporating, it is not suited for high-speed transfer recording, and if high-speed recording is attempted using a recording head which has the same width as that of paper, there is a limit to the increase in speed. In addition, it is not applicable to impermeable paper.

Or, in another proposal, powder which can be dissolved or swollen by liquid is pre-formed on the intermediate transfer body, and after forming an image on the transfer body by ink jet recording head, the image is transferred onto the recording medium (see, for example, JP-A No. 11-188858).

In this method, however, when transferring the swollen resin, the resin may be crushed by the pressure of transfer, and may spread-out on the transfer body to give image distortion, and a higher pattern fastness is demanded.

### SUMMARY OF THE INVENTION

The present invention has been made in view of the above circumstances and provides a pattern forming method and a pattern forming apparatus using an intermediate transfer system with a liquid droplet ejection device.

A first aspect of the invention provides a pattern forming method comprising: forming a liquid receptive particle layer on an intermediate transfer body by using liquid receptive particles capable of receiving a recording liquid containing recording material; applying liquid droplets of the recording liquid at specified positions of the liquid receptive particle layer on the basis of specified data, trapping the recording material near the surface of the liquid receptive particle layer on the intermediate transfer body, and forming a pattern of the recording material near the surface of the liquid receptive particle layer; and peeling the liquid receptive particle layer containing the recording liquid from the intermediate transfer body and transferring the liquid receptive particle layer onto a transfer object so that the pattern is placed between the transfer object and the liquid receptive particle layer.

A second aspect of the invention provides a pattern forming apparatus comprising: an intermediate transfer body; a particle supply unit for forming a liquid receptive particle layer of a specified layer thickness by supplying liquid receptive particles, capable of receiving a recording liquid containing recording material and also capable of trapping the recording material at the surface thereof, onto the intermediate transfer body; a liquid droplet ejection unit for ejecting liquid droplets of the recording liquid onto the liquid receptive particle layer on the basis of specified data, and forming a pattern of the recording material near the surface of the liquid receptive particle layer; and a transferring unit, for transferring the liquid receptive particle layer containing the recording liquid onto a transfer object so that the pattern is placed between the transfer object and the liquid receptive particle layer.

A third aspect of the invention provides a pattern forming apparatus comprising: an intermediate transfer body; a protective layer forming unit for forming a protective layer on the intermediate transfer body; a particle supplying unit for supplying liquid receptive particles, capable of receiving a recording liquid containing a recording material and also capable of trapping the recording material at the surface thereof, onto the intermediate transfer body and forming a liquid receptive particle layer of a specified layer thickness; a liquid droplet ejection unit for ejecting liquid droplets of the recording liquid onto the liquid receptive particle layer on the basis of specified data, and forming a pattern of the recording material on the liquid receptive particle layer; and a transferring unit for transferring the protective layer and the liquid receptive particle layer containing the recording liquid onto a transfer object so that the protective layer is formed on the outermost front surface.

A forth aspect of the invention provides a pattern forming apparatus comprising: an intermediate transfer body; a particle supplying unit for supplying liquid receptive particle, capable of receiving a recording liquid containing a recording material and also capable of trapping the recording material at the surfaces thereof, onto the intermediate transfer body, and forming a liquid receptive particle layer of a specified layer thickness; a liquid droplet ejection unit for applying liquid droplets of the recording liquid onto the liquid receptive particle layer on the basis of specified data, and forming a pattern of the recording material near the surface of the liquid receptive particle layer; a removing unit for removing the liquid receptive particles in a region not forming the pattern; and a transferring unit for transferring the liquid receptive particle layer containing the recording liquid onto a transfer object so that the pattern is placed between the transfer object and the liquid receptive particle layer.

### BRIEF DESCRIPTION OF THE DRAWINGS

Preferred embodiments of the present invention will be described in detail based on the following figures, in which:

FIG. 1 is a block diagram of a pattern forming apparatus according to a first embodiment of the invention;

FIG. 2A is a diagram of main parts of the pattern forming apparatus according to the first embodiment of the invention;

FIG. 2B is a schematic diagram of ink receptive particles;

FIG. 3A is a diagram of an ink receptive particle layer on an intermediate transfer body according to the first embodiment;

FIG. 3B is a diagram of the ink receptive particle layer after transferring onto a recording medium;

FIG. 4 is a block diagram of a pattern forming apparatus according to a second embodiment of the invention;

FIG. 5A is a diagram of main parts of the pattern forming apparatus according to the second embodiment of the invention;

FIG. 5B is a schematic diagram of ink receptive particles;

FIG. 6A is a diagram of an ink receptive particle layer on an intermediate transfer body in the second embodiment;

FIG. 6B is a diagram of the ink receptive particle layer after transferring onto a recording medium;

FIG. 7 is a block diagram of a pattern forming apparatus according to a third embodiment of the invention;

FIG. 8A is a diagram of main parts of the pattern forming apparatus according to the third embodiment of the invention;

FIG. 8B is a schematic diagram of ink receptive particles;

FIG. 9A is a diagram of an ink receptive particle layer on an intermediate transfer body in the third embodiment;

FIG. 9B is a diagram of the ink receptive particle layer after transferring onto a recording medium.

FIG. 10 is a diagram explaining the relation of charge voltage and bias potential;

FIG. 11 is a graph showing physical properties of protective agent;

FIG. 12 is a block diagram of a pattern forming apparatus according to a fourth embodiment of the invention;

FIG. 13 is a diagram of a first modified example of the pattern forming apparatus according to the third embodiment of the invention;

FIG. 14 is a diagram of a second modified example of the pattern forming apparatus according to the third embodiment of the invention;

FIG. 15A is a block diagram of a pattern forming apparatus according to a fifth embodiment of the invention;

FIG. 15B is a structural diagram of a fixing device;

FIG. 16A is a block diagram of a pattern forming apparatus according to a sixth embodiment of the invention;

FIG. 16B is a structural diagram of a fixing device;

FIG. 17A is a block diagram of a pattern forming apparatus according to a seventh embodiment of the invention;

FIG. 17B is a structural diagram of a fixing device;

FIG. 18 is a block diagram of a pattern forming apparatus according to an eighth embodiment of the invention;

FIG. 19 is a block diagram of a pattern forming apparatus according to a ninth embodiment of the invention;

FIG. 20 is a block diagram of a pattern forming apparatus according to a tenth embodiment of the invention;

FIG. 21 is a block diagram of a pattern forming apparatus according to an eleventh embodiment of the invention;

FIG. 22 is a block diagram of a pattern forming apparatus according to a twelfth embodiment of the invention;

FIG. 23 is a block diagram of a pattern forming apparatus according to a thirteenth embodiment of the invention;

FIG. 24 is a block diagram of a pattern forming apparatus according to a fourteenth embodiment of the invention;

FIG. 25 is a conceptual diagram of an example of ink receptive particles of the invention;

FIG. 26 is a conceptual diagram of another example of ink receptive particles of the invention; and

FIG. 27 is a conceptual diagram of another example of ink receptive particles of the invention.

### DETAILED DESCRIPTION OF THE INVENTION

Referring now to the accompanying drawings, embodiments of the present invention are specifically described below.

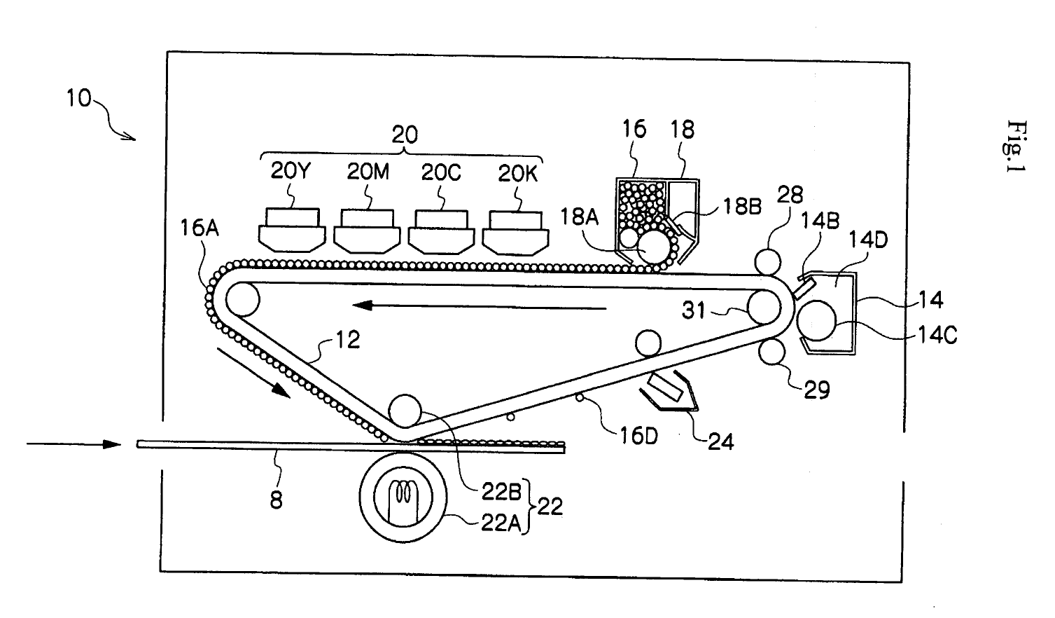

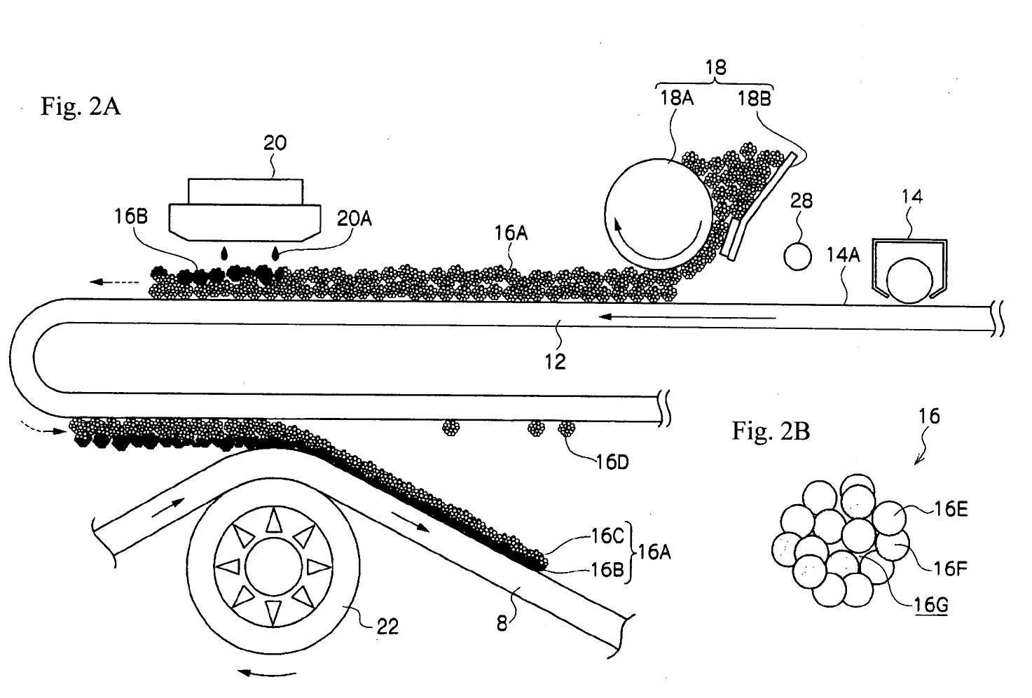

FIG. 1 is a block diagram of a pattern forming apparatus according to a first embodiment of the invention, and main parts of the pattern forming apparatus are shown in FIG. 2A.

As shown in FIG. 1 and FIG. 2A, a pattern forming apparatus 10 of the embodiment comprises an endless belt-shaped intermediate transfer body 12, a charging device 28 for charging the surface of the intermediate transfer body 12, a particle applying device 18 for forming a particle layer by adhering ink receptive particles 16 in a uniform and specified thickness onto a charged region on the intermediate transfer body 12, an ink jet recording head 20 for forming an image by ejecting ink droplets onto the particle layer, and a transfer fixing device 22 for transferring and fixing an ink receptive particle layer on a recording medium (or a transfer object) 8 by overlapping the intermediate transfer body 12 with the recording medium 8 and by applying pressure and heat.

The pattern forming apparatus according to the first embodiment is, regardless of the type of recording medium, free from bleeding or image disturbance, in particular due to undried liquid droplets on impermeable paper, excellent in image fastness, and capable of high-speed recording.

At the upstream side of charging device 28, a releasing agent applying device 14 is disposed for forming a releasing layer 14A (FIG. 2A) for promoting releasing of an ink receptive particle layer 16A from the surface of intermediate transfer body 12, in order to enhance transfer efficiency of ink receptive particle layer 16A onto the recording medium 8 from the surface of intermediate transfer body 12.

An electric charge is formed on the surface of intermediate transfer body 12 by the charging device 28, and on the charged surface of the intermediate transfer body 12, ink receptive particles 16 are applied and adhered uniformly in a specified thickness from the particle applying device 18, and an ink receptive particle layer 16A is formed. On the ink receptive particle layer 16A, as shown in FIG. 2A, ink droplets 20A in each color are ejected from inkjet recording heads 20 of individual colors, that is, 20K, 20C, 20M, 20Y, and a color image layer 16B is formed.

The ink receptive particle layer 16A on which the color image layer 16B is formed is transferred onto the recording medium 8 in each color images by the transfer fixing device 22. At the downstream side of the transfer fixing device 22, a cleaning device 24 is disposed for removing deposits sticking onto the intermediate transfer body such as ink receptive particles 16 remained on the surface of intermediate transfer body 12, and foreign matter (paper dust of recording medium 8 or the like) other than particles.

The recording medium 8 on which the color image is transferred is directly conveyed out, and the surface of the intermediate transfer body 12 is charged again by charging device 28. At this time, ink receptive particles 16 transferred onto the recording medium 8 absorb and hold the ink droplets 20A, and can be discharged quickly, and the productivity of the apparatus as a whole can be enhanced as compared with the conventional method of absorbing ink in the recording medium 8.

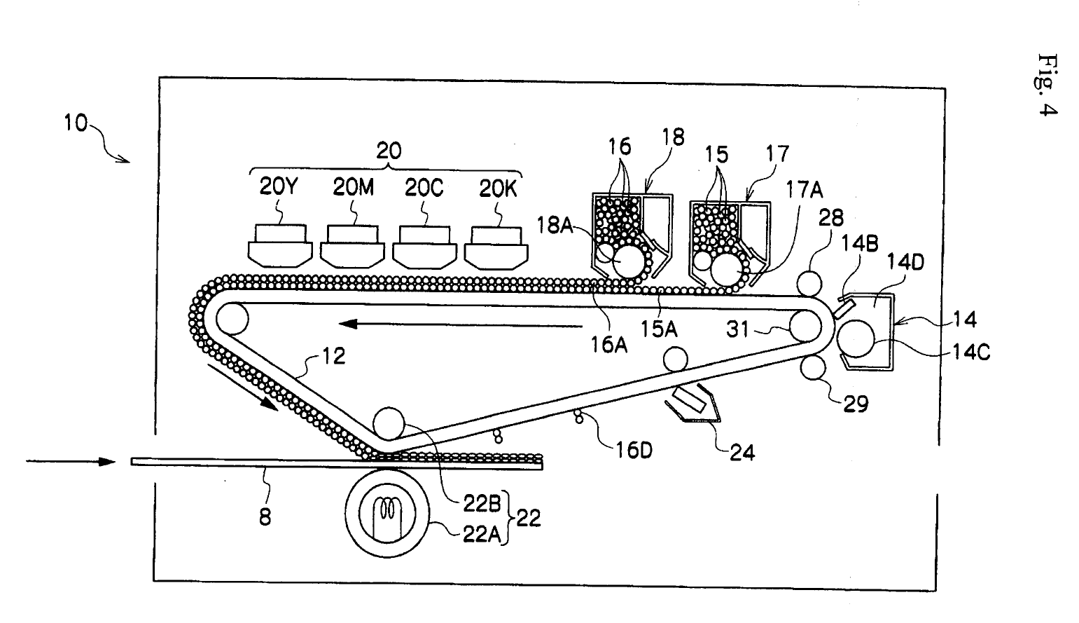

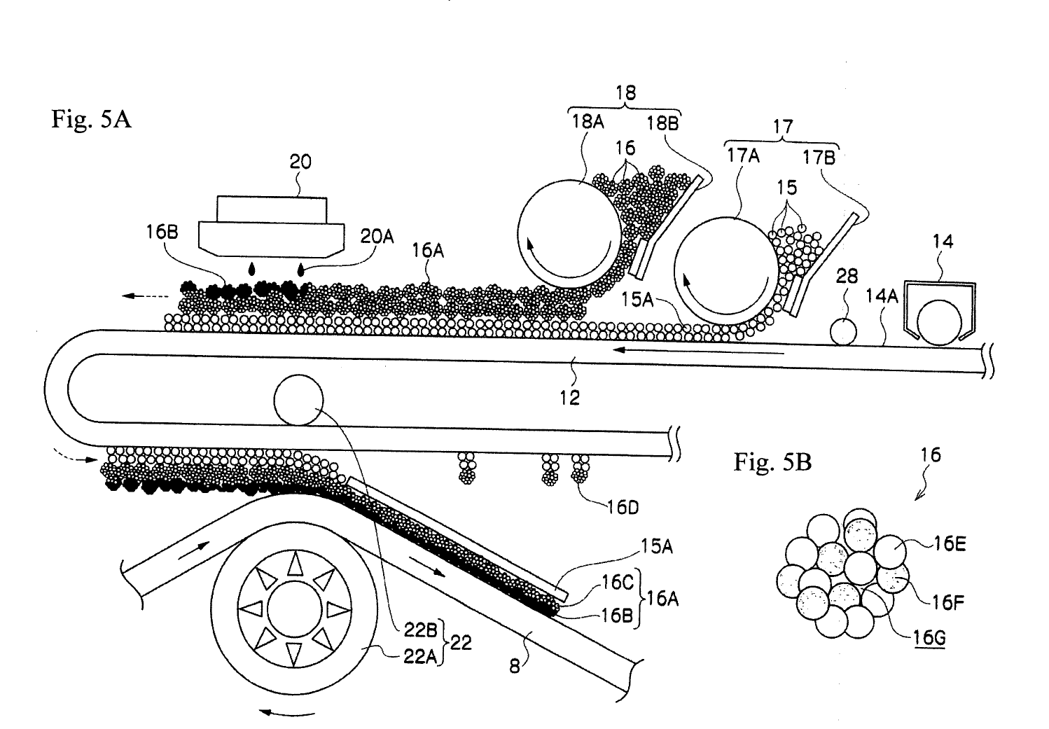

The pattern forming apparatus of the embodiment may also include a protective layer forming unit for forming a protective layer on the intermediate transfer body. Such pattern forming apparatus is shown as the second embodiment in FIG. 4, and its main parts are shown in FIG. 5A.

In the second embodiment of the invention, as shown in FIG. 4 and FIG. 5A, a pattern forming apparatus 10 comprises an endless belt-shaped intermediate transfer body 12, a charging device 28 for charging the surface of the intermediate transfer body 12, a protective particle applying device 17 for applying protective particles 15 in a charged region onto the intermediate transfer body 12 uniformly in a specified thickness to form a protective particle layer 15A, an ink receptive particle applying device 18 for applying ink receptive particles 16 in a charged region onto the intermediate transfer body 12 uniformly in a specified thickness to form an ink receptive particle layer 16A, an ink jet recording head 20 for forming an ink image layer 16B by ejecting ink droplets 20A onto the ink receptive particle layer 16A, and a transfer fixing device 22 for transferring and fixing an ink receptive particle layer on a recording medium 8 by overlapping the intermediate transfer body 12 with the recording medium 8 and by applying pressure and heat.

The pattern forming apparatus according to the second embodiment forms a protective layer on the intermediate transfer body, and forms a liquid receptive particle layer of liquid receptive particles capable of receiving a recording liquid on this protective layer. Onto the liquid receptive particle layer, the recording liquid is applied, and recording material is trapped at the particle layer, and therefore, a pattern of recording material is formed on the liquid receptive particle layer.

In order that the protective layer may be formed on the outermost surface, the protective layer and liquid receptive particle layer are peeled off from the intermediate transfer body, and transferred onto a transfer object.

Therefore, the outermost layer is securely covered with the protective layer, and the pattern is not exposed. Hence, the pattern fastness is excellent.

Since the protective layer has a releasing action, the transfer efficiency onto the transfer object is also improved.

Further, since the recording material is trapped at the liquid receptive particle layer, bleeding or pattern deterioration is slight. Further, regardless of type of the transfer object, bleeding or image disturbance due to undried liquid droplets on impermeable paper does not occur, and the pattern (image) can be formed by high-speed recording.

In the pattern forming apparatus according to the second embodiment, as the same in the first embodiment, at the upstream side of the charging device 28, a releasing agent applying device 14 is disposed for forming a releasing layer 14A (FIG 5A) for promoting releasing of an ink receptive particle layer 16A from the surface of intermediate transfer body 12 in order to enhance transfer efficiency of protective particle layer 15A and ink receptive particle layer 16A onto the recording medium 8 from the surface of intermediate transfer body 12. In order to provide the protective layer with a releasing action, as above, protection layer forming unit can be also served as releasing layer forming unit. In this case, the releasing agent application device is not required.

An electric charge is formed on the surface of intermediate transfer body 12 by the charging device 28, and on the charged surface of the intermediate transfer body 12, protective particles 15 are applied and adhered uniformly in a specified thickness from the protective particle applying device 17, and a protective particle layer 15A is formed. Further, on this protective particle layer 15A, ink receptive particles 16 are applied and adhered uniformly in a specified thickness from the particle applying device 18, and an ink receptive particle layer 16A is formed.

On the ink receptive particle layer 16A, ink droplets 20A in each color are ejected from ink jet recording heads 20 of individual colors, that is, 20K, 20C, 20M, 20Y, and an ink image layer 16B is formed.

The ink receptive particle layer 16A on which the color image layer 16B is formed and the protective particle layer 15A beneath it are transferred onto the recording medium 8 by the transfer fixing device 22, and the ink image layer 16B is transferred and fixed onto the recording medium.

At the downstream side of the transfer fixing device 22, as in the first embodiment, a cleaning device 24 is disposed for removing deposits sticking onto the intermediate transfer body such as ink receptive particles 16 and protective particles 15 remaining on the surface of intermediate transfer body 12, and foreign matter (paper dust of recording medium 8 or the like) other than particles.

The recording medium 8, onto which ink receptive particle layer 16A on which ink image layer 16B is formed and the protective particle layer 15A beneath it are transferred, is directly conveyed out, and the surface of intermediate transfer body 12 is charged again by the charging device 28. At this time, ink droplets 20A are absorbed and held in the ink receptive particles 16 transferred onto the recording medium 8. Since the protective particles 15 are non-receptive to the ink, compared with the conventional method of absorbing ink on the recording medium 8, it can be conveyed out more promptly. As a result, the productivity of the apparatus over all is improved.

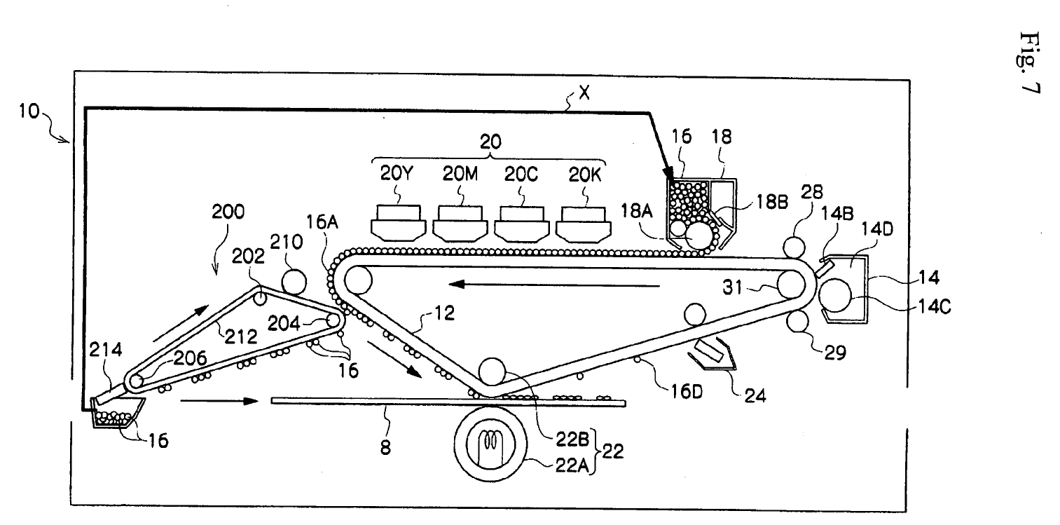

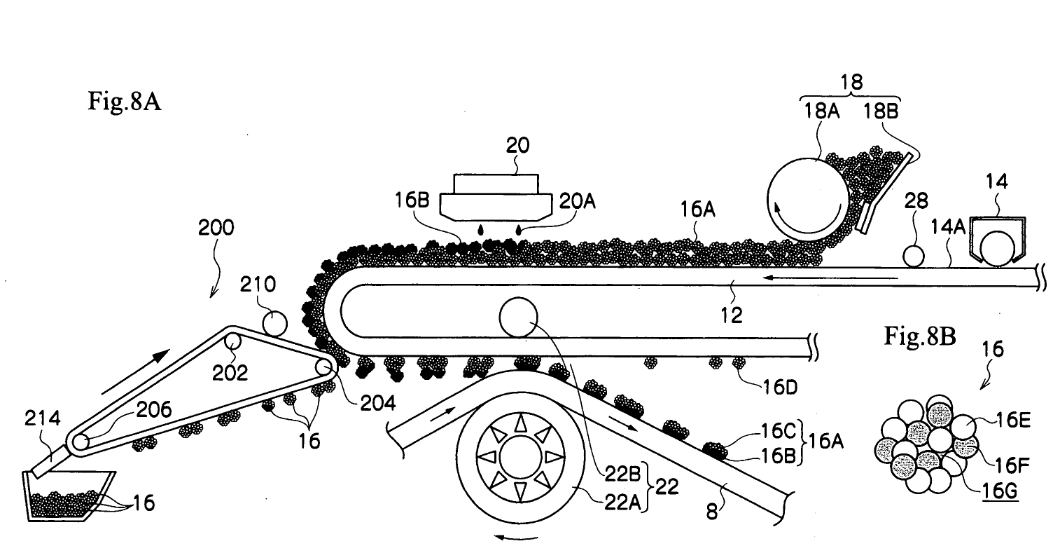

The pattern forming apparatus of the embodiment may also include a device for removing ink receptive particles 16 in the region other than the ink image layer. Such a pattern forming apparatus including a removing device is shown as a third embodiment in FIG. 7, and its main parts are shown in FIG. 8A. In the third embodiment of the invention, as shown in FIG. 7 and FIG. 8A, a pattern forming apparatus 10 comprises an endless belt-shaped intermediate transfer body 12, a charging device 28 for charging the surface of the intermediate transfer body 12, an ink receptive particle applying device 18 for applying and adhering ink receptive particles 16 in a charged region onto the intermediate transfer body 12 uniformly in a specified thickness to form a particle layer, an ink jet recording head 20 for forming an image by ejecting ink droplets on the particle layer, a removing device 200 for removing ink receptive particles 16 in the region other than the ink image layer 16B, and a transfer fixing device 22 for transferring and fixing the ink receptive particle layer onto the recording medium 8 by overlapping the intermediate transfer body 12 with a recording medium 8 and by applying pressure and heat.

The pattern forming apparatus according to the third embodiment applies a recording liquid to a liquid receptive particle layer, formed on the intermediate transfer body by liquid receptive particles capable of receiving the recording liquid containing recording material, traps the recording material near the surface of the particle layer, and forms a pattern of recording material in the liquid receptive particle layer.

After removing the liquid receptive particles in the region not a forming pattern, the liquid receptive particle layer is peeled off from the intermediate transfer body and transferred onto a transfer object, so that the pattern is placed between the transfer object and the liquid receptive particle layer.

Therefore, the liquid receptive particles in the region not forming a pattern are not transferred onto the transfer object. Hence, for example, the texture of the material of transfer object may be maintained, and thinness, lightness, and flexibility of the transfer object can be utilized.

Further, since the recording material is trapped at the liquid receptive particle layer, bleeding or pattern deterioration is slight. Regardless of the type of transfer object, bleeding or image disturbance due to undried liquid droplets particularly on impermeable paper does not occur, pattern fastness is excellent, and yet the pattern (image) can be formed with high speed recording.

In the pattern forming apparatus according to the third embodiment, as in the first embodiment, at the upstream side of the charging device 28, a releasing agent applying device 14 is disposed for forming a releasing layer 14A (FIG. 8A) for promoting releasing of the ink receptive particle layer 16A from the surface of intermediate transfer body 12, in order to enhance transfer efficiency of ink receptive particle layer 16A onto the recording medium 8 from the surface of intermediate transfer body 12.

An electric charge is formed on the surface of intermediate transfer body 12 by the charging device 28, and on the charged surface of the intermediate transfer body 12, ink receptive particles 16 are applied and adhered uniformly in a specified thickness from the particle applying device 18, and an ink receptive particle layer 16A is formed. On the particle layer, further, ink droplets 20A in each color are ejected from ink jet recording heads 20 of individual colors, that is, 20K, 20C, 20M, 20Y, a full color ink image layer 16B is formed.

Of the ink receptive particle layer 16A having the ink image layer 16B formed on the surface, the region other than the area forming the ink image layer 16B is almost completely removed by the removing device 200.

The ink receptive particle layer 16A is transferred onto the recording medium 8 by the transfer fixing device 22, together with ink image layer 16B.

At the downstream side of the transfer fixing device 22, a cleaning device 24 is disposed for removing deposits sticking on the intermediate transfer body 12 such as ink receptive particles 16 remaining on the surface of intermediate transfer body 12, and foreign matter (paper dust of recording medium 8 or the like) other than particles.

The recording medium 8 on which the ink image layer 16B is transferred is directly conveyed out, and the intermediate transfer body 12 is charged again on the surface by the charging device 28. At this time, ink droplets 20A are absorbed and held in the ink receptive particles 16 transferred onto the recording medium 8, and it can be conveyed out more promptly, as compared with the conventional method of absorbing ink in the recording medium 8, and the productivity of the apparatus over all is improved.

In the pattern forming apparatus according to the first to third embodiments, as required, a neutralization apparatus 29 may be installed between the cleaning device 24 and the releasing agent applying device 14 in order to remove the residual electric charge on the surface of the intermediate transfer body 12.

In the pattern forming apparatus of an embodiment, the intermediate transfer body 12 is composed of a base layer of polyimide film of 1 mm in thickness, on which a surface layer of ethylene propylene diene monomer (EPDM) rubber of 400 μm in thickness is formed. Herein, the surface resistivity is preferably approximately 10E13 ohms/square, and the volume resistivity is approximately 10E12 ohms-cm (semi-conductivity).

The intermediate transfer body 12 is moved to convey, and a releasing layer 14A is formed on the intermediate transfer body 12 by the releasing agent applying device 14. A releasing agent 14D is applied on the surface of the intermediate transfer body 12 by an application roller 14C of the releasing agent applying device 14, and the layer thickness is regulated by the blade 14B. The blade 14B is omitted in FIG. 2A, FIG. 5A, and FIG. 8A.

At this time, in order to form image and print continuously, the releasing agent applying device 14 may be formed to continuously contact with the intermediate transfer body 12, or may be appropriately separated from the intermediate transfer body 12.

From an independent liquid supply system (not shown), a releasing agent 14D may be supplied into the applying device, so that the supply of releasing agent 14D is not interrupted. In this embodiment, amino silicone oil is used as releasing agent 14D. Other usable examples of the releasing agent include modified silicone oil, fluorine-based oil, hydrocarbon-based oil, mineral oil, vegetable oil, polyalkylene glycol, alkylene glycol ether, alkane diol, and fused wax.

By applying a positive charge onto the surface of intermediate transfer body 12 by the charging device 28, a positive charge is applied onto the surface of intermediate transfer body 12. A potential capable of supplying and adsorbing ink receptive particles 16 onto the surface of intermediate transfer body 12 may be formed by an electrostatic force of electric field which can be formed between the ink receptive particle supply roll 18A of ink receptive particle applying device 18 and the surface of intermediate transfer body 12.

On the other hand, in the second embodiment including the protective layer forming unit, by applying a positive charge onto the surface of intermediate transfer body 12 by the charging device 28, the surface of intermediate transfer body 12 is charged positively. Here, a potential capable of supplying and adsorbing protective particles 15 and ink receptive particles 16 onto the surface of intermediate transfer body 12 may be formed by the electrostatic force of electric field which can be formed between the protective particle feed roll 17A of protective particle applying device 17 and the ink receptive particle supply roll 18A of ink receptive particle applying device 18, and the surface of intermediate transfer body 12.

In the embodiments of the invention, using the charging device 28, a voltage is applied between the charging device 28 and a driven roll 31 (connected to ground), between which the intermediate transfer body 12 is disposed, and the surface of the intermediate transfer body 12 is charged.

The charging device 28 is a roll shape member adjusted to a volume resistivity of 10E6 to 10E8 ohms-cm which forms an elastic layer (foamed urethane resin) dispersed with a conductive material on the outer circumference of stainless steel bar material. The surface of elastic layer is coated with a skin layer (PFA) of water-repellent and oil-repellent property of approximately 5 to 100 μm in thickness. It is hence effective in suppressing characteristic changes (changes in resistance value) due to humidity changes in the apparatus, or sticking of releasing agent to the charged layer surface.

A power source is connected to the charging device 28, and the driven roll 31 is electrically connected to the frame ground. The charging device 28 is driven together with the driven roll 31, while the intermediate transfer body 12 is disposed between the charging device 28 and the driven roll 31, and at the pressed position, since a specified potential difference occurs against the grounded driven roll 31, an electric charge can be applied onto the surface of the intermediate transfer body 12. Here, a DC voltage of 1 kV (constant voltage control) is applied onto the surface of intermediate transfer body 12 by the charging device 28, and the surface of the intermediate transfer body 12 is charged. AC voltage may be superimposed on the DC voltage.

The charging device 28 may be composed of corotron or brush. In this case, the voltage is applied under almost the same conditions as above. In particular, the corotron can apply an electric charge to the intermediate transfer body 12 without making contact.

In the first embodiment, ink receptive particles 16 are supplied from the particle applying device 18 onto the surface of the intermediate transfer body 12, and an ink receptive particle layer 16A is formed. The particle applying device 18 has an ink receptive particle supply roll 18A in the portion facing the intermediate transfer body 12 in the container containing the ink receptive particles 16, and a charging blade 18B is disposed so as to press the ink receptive particle supply roll 18A. The charging blade 18B also functions to regulate the film thickness of the ink receptive particles 16 applied and adhered onto the surface of the ink receptive particle supply roll 18A.

On the other hand, in the second embodiment including a protective layer forming unit, protective particles 15 are supplied from the protective particle applying device 17 onto the surface of the intermediate transfer body 12, and a protective particle layer 15A is formed. The protective particle applying device 17 has a protective particle supply roll 17A in the portion facing the intermediate transport body 12 in the container containing the protective particles 15, and a charging blade 17B is disposed so as to press the protective particle supply roll 17A. The charging blade 17B also functions to regulate the film thickness of the protective particles 15 applied and adhered onto the surface of the protective particle supply roll 18A.

In the second embodiment, ink receptive particles 16 are supplied from the ink receptive particle applying device 18 onto the protective particle layer 15A, and an ink receptive particle layer 16A is formed. The ink receptive particle applying device 18 also includes the ink receptive particle supply roll 18A and the charging blade 18B arranged so as to press the ink receptive particle supply roll 18A.

Specifically, protective particles 15 include the following materials.

Examples are:

Styrenes such as styrene, parachlorostyrene, alpha-methyl styrene, alpha-ethyl styrene or the like; esters having a vinyl group, such as methyl acrylate, ethyl acrylate, n-propyl acrylate, lauryl acrylate, 2-ethyl hexyl acrylate, methyl methacrylate, ethyl methacrylate, n-propyl methacrylate, butyl methacrylate, lauryl methacrylate, 2-ethyl hexyl methacrylate, alkyl acrylate, phenyl acrylate, alkyl methacrylate, phenyl methacrylate, cycloalkyl methacrylate, alkyl crotonate, dialkyl itaconate, dialkyl maleate or the like; vinyl nitriles such as acrylonitrile, methacrylonitrile or the like; vinyl ethers such as vinyl methyl ether, vinyl isobutyl ether or the like; vinyl ketones such as vinyl methyl ketone, vinyl ethyl ketone, vinyl isopropenyl ketone or the like; vinyl cyclohexane, vinyl naphthalene, vinyl naphthalene derivatives; polyolefins such as ethylene, propylene, butadiene or the like; and monomers or polymers, or copolymers obtained by combining two or more types thereof or their mixtures; and epoxy resins, polyester resins, polyurethane resins, polyamide resins, cellulose resins, polyether resins, and non-vinyl condensation system resins, and the like.

The glass transition temperature (Tg) of protective particles 15 is preferably about 40 deg. C. to 90 deg. C., and more preferably about 50 deg. C. to 70 deg. C.

Particle size of protective particles 15 is preferably about 0.5 μm to 60 μm in average equivalent spherical diameter, more preferably about 1 μm to 30 μm, or even more preferably 3 μm to 15 μm.

Ink receptive particles 16 may be composed as follows.

(Ink Receptive Particles A-1)

100 parts of Styrene/n butyl methacrylate/acrylic acid copolymer particles (volume average particle diameter 0.2 μm, acid value=240, partially neutralized with a sodium hydroxide, Tg=approximately 60 deg. C.)
30 parts of Amorphous silica particles (1:1 mixture of Aerosil OX50 (trade name, manufactured by Nippon Aerosil Co., Ltd., volume average particle diameter=approximately 40 nm) and Aerosil TT600 (trade name, manufactured by Nippon Aerosil Co., Ltd., volume average particle diameter=40 nm))

These particles are mixed, and a trace of sterilizer aqueous solution (Proxel GXL(S), trade name, manufactured by Arch Chemicals Japan) are added, stirred and mixed (approximately 30 seconds by sample mill), then processed intermittently by mechano-fusion system, and made into composite particles. Particle size is measured at every intermittent driving state, and particles are taken out at the stage of approximately 5 μm. By granulating in this manner, aggregated composite particles (base particles a1) of average equivalent spherical diameter of 5 μm are manufactured.

To these aggregated composite particles (base particles a1), 1.0 mass % of hydrophobic surface-treated silica particles (Aerosil R972, trade name, manufactured by NIPPON AEROSIL CO., LTD., volume average particle diameter=approximately 16 nm) and 0.5 mass % of untreated hydrophilic silica particles (Aerosil 130, trade name, manufactured by Japan Aerosil, volume average particle diameter=approximately 16 nm) are added externally, and particles A-1 are prepared. The resulting particles A-1 are used as ink receptive particles 16.

Ink receptive particles 16 are supplied by ink receptive particle supply roll 18A (conductive roll), and the ink receptive particle layer 16A is regulated by the charging blade 18B, and is charged negatively with the reverse polarity of the electric charge on the surface of the intermediate transfer body 12. In the second embodiment, by supply rolls 17A, 18A, respectively, protective particles 15 and ink receptive particles 16 are respectively supplied, and the protective particle layer 15A and ink receptive particle layer 16A are respectively regulated by the charging blades 17B, 18B, and are charged negatively with the reverse polarity of the electric charge on the surface of the intermediate transfer body 12. The supply rolls 17A, 18A are aluminum solid rolls, and the charging blades 17B, 18B are made of metal plates (such as SUS, or the like) being coated with urethane rubber or the like in order to apply pressure. The charging blades 17B, 18B are contacting with supply rolls 17A, 18A in a type of doctor blades.

The charged ink receptive particles 16 form, for example, approximately one layer of particles on the surface of the ink receptive particle supply roll 18A, and are conveyed to a position opposite to the surface of intermediate transfer body 12. When closing to the intermediate transfer body 12, the charged ink receptive particles 16 are moved electrostatically onto the surface of intermediate transfer body 12 by the electric field formed by the potential difference on the surfaces of the ink receptive particle supply roll 18A and the intermediate transfer body 12

At this time, the relative ratio (peripheral speed ratio) of moving speed of intermediate transfer body 12 and rotating speed of supply roll 18A are determined such that approximately one layer of particles on the surface of intermediate transfer body 12. This peripheral speed ratio depends on the charging amount of intermediate transfer body 12, charging amount of ink receptive particles 16, relative position of supply roll 18A and intermediate transfer body 12, and other parameters.

On the basis of the peripheral speed ratio for forming approximately one layer of the ink receptive particle layer 16A, if the peripheral speed of ink receptive particle supply roll 18A is relatively accelerated, the number of particles supplied on the intermediate transfer body 12 may be increased. It is hence possible to control the layer thickness of ink receptive particle layer 16A formed on the intermediate transfer body 12. That is, when the transferred image density is low (an amount of the ink loaded is small), the layer thickness is regulated to a minimally required limit, and when the image density is high (an amount of the ink loaded is large), it is preferred to regulate to a sufficient layer thickness for holding the ink solvent.

In the second embodiment, the charged protective particles 15 and ink receptive particles 16, respectively, form, for example, approximately one layer of particles on the surface of supply rolls 17A, 18A, respectively, and are conveyed to a position opposite to the surface of intermediate transfer body 12. When closing to the intermediate transfer body 12, the charged protective particles 15 and ink receptive particles 16 are moved electrostatically by the electric field formed by the potential difference on the surfaces of the supply rolls 17A, 18A and intermediate transfer body 12.

In the second embodiment, charge potential V₀ of intermediate transfer body 12, bias potential V_{L1} of protective particle supply roll 17A, and bias potential V_{L2} of ink receptive particle supply roll 18A are explained below.

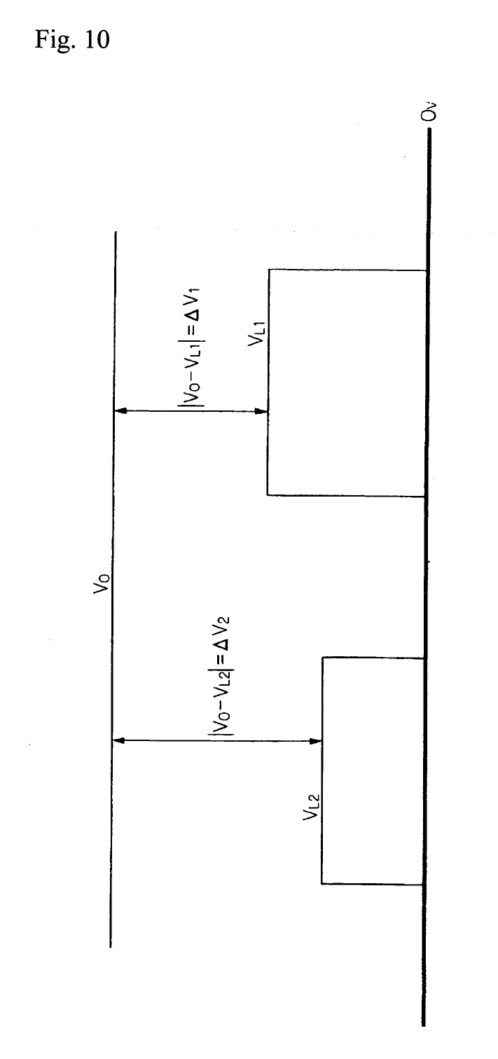

As shown in FIG. 10, the intermediate transfer body 12 is charged to specified charge potential V₀ by the charging device 28. Bias potential V_{L1} is applied to protective particle supply roll 17A of protective particle applying device 17, and the charged protective particles 15 are moved electrostatically by the electric field formed by the potential difference (ΔV1) between charge potential V₀ and bias potential V_{L1}. Similarly, bias potential V_{L2} is applied to ink receptive particle supply roll 18A of ink receptive particle applying device 18, and the charged ink receptive particles 16 are moved electrostatically by the electric field formed by the potential difference (ΔV₂) between charge potential V₀ and bias potential V_{L2}.

The potential difference (ΔV₂) of charge potential V₀ and bias potential V_{L2} is set to be larger than the potential difference (ΔV₁) of charge potential V₀ and bias potential V_{L1}. This is because the distance between the ink receptive particle supply roll 18A of ink receptive particle applying device 18, and the intermediate transfer body 12 is greater than the distance between protective particle supply roll 17A, of protective particle applying device 17, and the intermediate transfer body 12, and the potential difference is increased by a corresponding amount (the intensity of electric field is potential difference/distance).

At this time, the relative ratio (peripheral speed ratio) of moving speed of intermediate transfer body 12 and rotating speed of supply rolls 17A, 18A are determined such that approximately one layer of particles is formed. This peripheral speed ratio depends on the charging amount of intermediate transfer body 12, charging amount of protective particles 15 and ink receptive particles 16, relative position of supply rolls 17A, 18A and intermediate transfer body 12, and other parameters.

On the basis of the peripheral speed ratio for forming approximately one layer of protective particle layer 15A and ink receptive particle layer 16A, if the peripheral speed of supply rolls 17A, 18A is relatively accelerated, the number of particles supplied onto the intermediate transfer body 12 may be increased. It is hence possible to control the layer thickness of protective particle layer 15A and ink receptive particle layer 16A formed on the intermediate transfer body 12.

That is, when the transferred image density is low (an amount of the ink loaded is small), the layer thickness is regulated to a minimally required limit, and when the image density is high (an amount of the ink loaded is large), it is preferred to regulate to a sufficient layer thickness enough to hold the ink solvent.

For example, in the case of a character image at which an amount of ink loaded is small, when forming an image on an ink receptive particle layer 16A, which is approximately one layer, on the intermediate transfer body, the image forming material (pigment) in the ink is trapped near the surface of ink receptive particle layer 16A on the intermediate transfer body 12, and is fixed on the surface of porous particles or fixing particles forming the ink receptive particles 16, so that the distribution is smaller in the depth direction. Accordingly, after transferring and fixing, the image forming material (pigment) of which the image layer 16B is exposed on the surface is small (when the protective layer is provided, the image forming material (pigment) of which the ink image layer 16B exists immediately beneath the protective particle layer 15A is small), and sufficient fixing property against abrasion or the like is realized as compared with the case of forming an image directly on the recording material surface (the case where almost all pigment exists near the surface).

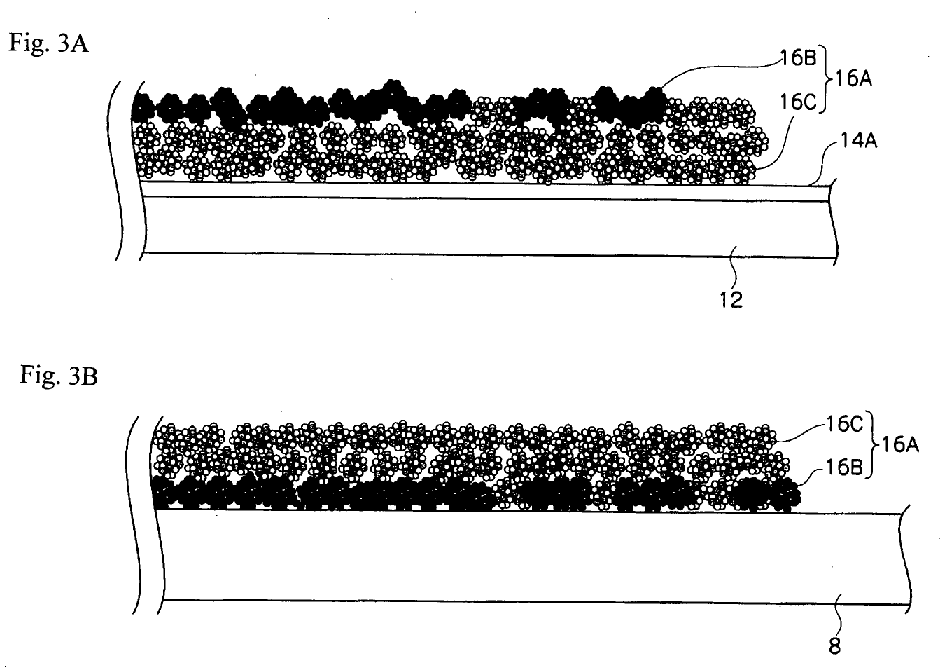

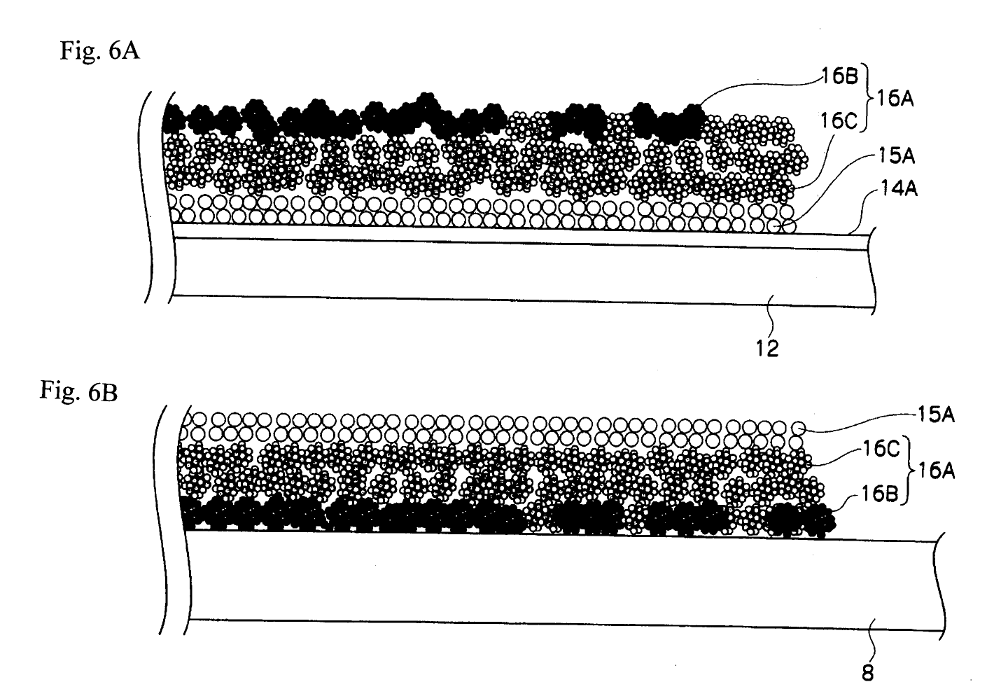

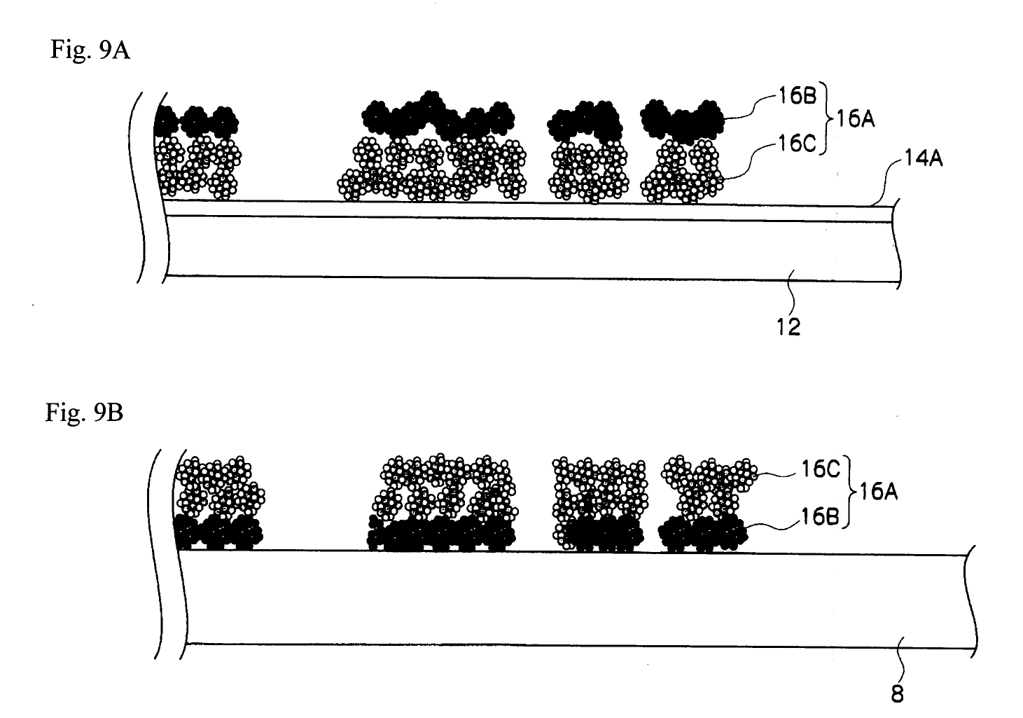

For example, if it is desired to form a layer 16C to be a protective layer (in the second embodiment, a layer 16C to be a protective layer and a protective particle layer 15A) on an image layer 16B to be a final image (see FIG. 3, FIG. 6, FIG. 9), the ink receptive particle layer 16A is formed at substantially three layers thick, and the ink image is formed on the highest layer only, so that the remaining two layers not forming image can be formed, on the image layer 16B as protective layers after transferring and fixing.

Alternatively, when forming an image in two or more colors, or an image at which an amount of ink loaded is large, ink receptive particles 16 are layered, so that the pigment is trapped on the surface of porous particles and fixing particles capable of holding the solvent in the ink and forming the ink receptive particles 16, and the number of particles is sufficient for the pigment not to reach the lowest layer. In this case, the image forming material (pigment) is not exposed on the image layer surface after transferring and fixing, and ink receptive particles not forming image may be formed as a protective layer on the image surface.

Next, the ink jet recording head 20 applies ink droplets 20A to the ink receptive particle layer 16A. Based on the specified image information, the ink jet recording head 20 applies ink droplets 20A to specified positions.

In the third embodiment, the removing device 200 removes ink receptive particles 16 in the region other than the ink image layer 16B from the intermediate transfer body 12.

The removing device 200 has an endless removing belt 212 stretched between stretching rolls 202, 204 and driving roll 206. The closest position of removing belt 212 and intermediate transfer belt 12 has a specified clearance so as not to contact with the ink receptive particle layer 16A.

The removing belt 212 rotatably moves, and charges with a specific surface potential (with reverse polarity of ink receptive particles 16) using the charging roll 210 to which a charging voltage is applied. In the closest position of a specified clearance, the ink receptive particles 16 are adsorbed to a neutrallizing belt 212 electrostatically.

The ink image layer 16B provided with ink droplets 20A is sticky due to the solvent content. Hence, the adhesion force to the intermediate transfer body 12 is different between the ink image layer 16B and areas other than image region. (The adhesion force in the ink image layer 16B is larger.)

By setting the electrostatic adsorbing force larger than the adhesion force in areas other than ink image layer 16B, but weaker than in the ink image layer 16B, it is possible to remove the ink receptive particles 16 only in the region other than ink image layer 16B. The electrostatic adsorbing force can be adjusted by the surface potential charged by the charging roll 210.

The ink receptive particles 16 in the ink image layer 16B are heavy because the liquid of the ink is permeated therein. Hence, the ink receptive particles 16 in the ink image layer 16B are less easily removed by the removing belt 212.

The removed ink receptive particles 16 are scraped off by the recovery blade 214 and collected. The collected ink receptive particles 16 may be discarded, or may be used again by putting back into the particle applying device 18 as indicated by arrow X. Or the particles may be returned into a supply tank (not shown) for supplying ink receptive particles 16 to the particle applying device 18, and recycled. Running cost is lowered by such recycling.

Finally, by nipping the recording medium 8 and intermediate transfer body 12 by the transfer fixing device 22, and applying pressure and heat to the ink receptive particle layer 16A, the ink receptive particle layer 16A is transferred onto the recording medium 8.

The transfer fixing device 22 is composed of a heating roll 22A incorporating a heating source, and a pressurizing roll 22B, between which the intermediate transfer body 12 is disposed and which are opposite, and the heating roll 22A and pressurizing roll 22B abut against each other to form a nip. The heating roll 22A and pressurizing roll 22B are, like a fixing device (fuser) of electrophotography, formed of an aluminum core, coated with silicone rubber on the outer surface, and are further covered with a PFA tube.

In the nip of heating roll 22A and pressurizing roll 22B, the ink receptive particle layer 16A is heated by the heater and is pressurized, and hence the ink receptive particle layer 16A is fixed simultaneously when transferred onto the recording medium 8.

At this time, resin particles in non-image portion are heated above the softening point (Tg), and are softened (or fused), and the ink receptive particle layer 16A (in the second embodiment, the protective layer 15A and ink receptive particle layer 16A) is released from the releasing layer 14A formed on the surface of intermediate transfer body 12 by the pressure, and is transferred and fixed on the recording medium 8. Since weakly liquid absorbing resin particles (fixing particles 16E) of the image portions loaded with ink are softened by absorbing the ink solvent, the ink receptive particle layer 16A is released from the releasing layer 14A formed on the surface of intermediate transfer body 12 by the pressure, and is transferred and fixed onto the recording medium 8. At this time, transfer fixing property is improved by heating. In this embodiment, the surface of heating roll 22A is controlled at 160 deg. C. At this time, the ink solvent held in the ink receptive particle layer 16A is held in the same ink receptive particle layer 16A even after transfer, and is fixed. Before the transfer fixing device 22, the efficiency of transfer and fixing may be enhanced by preheating the intermediate transfer body 12.

Referring to FIG. 2, FIG. 5, and FIG. 8, the pattern forming process according to the first to third embodiments of the invention is described below.

Relating to the first embodiment, the pattern forming method of the embodiment comprises: forming a liquid receptive particle layer on an intermediate transfer body by using liquid receptive particles capable of receiving a recording liquid containing recording material; applying liquid droplets of the recording liquid at specified positions of the liquid receptive particle layer on the basis of specified data, trapping the recording material near the surface of the liquid receptive particle layer on the intermediate transfer body, and forming a pattern of the recording material near the surface of the liquid receptive particle layer; and peeling the liquid receptive particle layer containing the recording liquid from the intermediate transfer body and transferring the liquid receptive particle layer onto a transfer object so that the pattern is placed between the transfer object and the liquid receptive particle layer.

In the embodiment having such a configuration, regardless of the type of recording medium, bleeding or disturbance of image due to undried liquid droplets especially on impermeable paper does not occur, a pattern (image) forming method excellent in image fastness and capable of high-speed recording can be attained.

Relating to the second embodiment, the pattern forming method of the embodiment comprises: forming a protective layer on an intermediate transfer body; forming a liquid receptive particle layer by using liquid receptive particles capable of receiving a recording liquid containing recording material, on the protective layer formed on the intermediate transfer; applying liquid droplets of the recording liquid at specified positions of the liquid receptive particle layer on the basis of specified data, trapping the recording material at the liquid receptive particle layer on the intermediate transfer body, and forming a pattern of the recording material on the liquid receptive particle layer; and peeling the protective layer and the liquid receptive particle layer containing the recording liquid from the intermediate transfer body so that the protective layer may be formed on the outermost surface, and transferring on a transfer object.

In this pattern forming method, a protective layer is formed on the intermediate transfer body, and on this the protective layer, a liquid receptive particle layer is formed by using liquid receptive particles capable of receiving a recording liquid. Further, on this liquid receptive particle layer, a recording liquid is applied, and recording material is trapped at the particle layer, and a pattern of recording material is formed onto the liquid receptive particle layer.

To form the protective layer on the outermost surface, the protective layer and liquid receptive particle layer are peeled off from the intermediate transfer body, and are transferred onto a transfer object.

The outermost surface is covered securely with a protective layer, and the pattern is not exposed. Hence, the pattern fastness is excellent.

By providing the protective layer with a releasing action, the transfer efficiency to the transfer object is also enhanced.

Further, since the recording material is trapped at the liquid receptive particle layer, bleeding or pattern deterioration is small. Regardless of the type of transfer object, bleeding or image disturbance due to undried liquid droplets particularly on impermeable paper does not occur, and the pattern (image) is formed by high-speed recording.

Relating to the third embodiment, the pattern forming method of the embodiment comprises: forming a liquid receptive particle layer on an intermediate transfer body by using liquid receptive particles capable of receiving a recording liquid containing a recording material; applying liquid droplets of the recording liquid at specified position of the liquid receptive particle layer on the basis of specified data, trapping the recording material near the surface of the liquid receptive particle layer on the intermediate transfer body, and forming a pattern of the recording material near the surface of the liquid receptive particle layer; removing the liquid receptive particles in a region not forming the pattern; and peeling the liquid receptive particle layer containing the recording liquid from the intermediate transfer body and transferring it onto the transfer object, so that the pattern is placed between a transfer object and the liquid receptive particle layer.

In this pattern forming method, a recording liquid is applied to a liquid receptive particle layer formed on the intermediate transfer body by using liquid receptive particles capable of receiving the recording liquid containing a recording material, the recording material is trapped near the surface of the particle layer, and a pattern of recording material is formed on the liquid receptive particle layer.

After removing the liquid receptive particles in the region not a forming pattern, the liquid receptive particle layer is peeled off the intermediate transfer body and transferred onto a transfer object, so that the pattern is placed between the transfer object and a layer of liquid receptive particles.

Therefore, the liquid receptive particles in the region not a forming pattern are not transferred onto the transfer object. Hence, for example, the texture of the material of transfer object may be maintained, and the thinness, lightness and ductility of the transfer object may not be spoiled.

Further, since the recording material is trapped at the liquid receptive particle layer, bleeding or pattern deterioration is slight. Regardless of the type of transfer object, bleeding or image disturbance due to undried liquid droplets particularly on impermeable paper does not occur, pattern fastness is excellent, and the pattern (image) can be formed in high-speed recording.

As shown in FIG. 2, FIG. 5, and FIG. 8, on the surface of intermediate transfer body 12, a releasing layer 14A formed by a releasing layer applying device 14 in order to prevent problems of sticking of ink receptive particles 16 due to moisture adhesion to the surface, as well as to secure releasing property when transferring. If the material of the intermediate transfer body 12 is aluminum or PET base, the effect of releasing layer 14A is large. Or by using the material such as fluorine resin or silicone rubber, the surface of the intermediate transfer body 12 may be provided with releasing property.

In FIG. 2 and FIG. 8, the surface of intermediate transfer body 12 is charged with the reverse polarity of the ink receptive particles 16 by the charging device 28. As a result, the ink receptive particles 16 supplied by the supply roll 18A of the particle applying device 18 can be adsorbed electrostatically, and a uniform layer of ink receptive particles 16 can be formed on the surface of the intermediate transfer body 12.

Further, on the surface of the intermediate transfer body 12, ink receptive particles 16 are formed as a uniform layer by the supply roll 18A of the particle applying device 18. For example, the ink receptive particle layer 16A is formed such that a thickness thereof corresponds to substantially three layers of particles. That is, the particle layer 16A is regulated to a desired thickness by the gap between the charging blade 18B and supply roll 18A, and thus, the thickness of the particle layer 16A transferred on the recording medium 8 is regulated. Or it may be regulated by the peripheral speed ratio of supply roll 18A and intermediate transfer body 12.

On the other hand, in FIG. 5, the surface of intermediate transfer body 12 is charged with reverse polarity of protective particles 15 and ink receptive particles 16, by the charging device 28. As a result, the protective particles 15 and ink receptive particles 16 supplied by the supply rolls 17A, 18A of the protective particle applying device 15 and ink receptive particle applying device 18 can be adsorbed electrostatically, and a uniform layer of protective particles 15 and ink receptive particles 16 can be formed on the surface of the intermediate transfer body 12.

Further, on the surface of the intermediate transfer body 12, protective particles 15 and ink receptive particles 16 are applied and formed sequentially as a uniform layer by the supply rolls 17A, 18A of the protective particle applying device 17 and ink receptive particle applying device 18.

For example, the protective particle layer 15A is formed such that a thickness thereof corresponds to substantially two layers of protective particles 15, and the ink receptive particle layer 16A is formed such that a thickness thereof corresponds to substantially three layers of ink receptive particles.

As mentioned above, regulation may be by the peripheral speed ratio of supply rolls 17A, 18A and intermediate transfer body 12, or the thickness of the protective particle layer 15A and ink receptive particle layer 16A transferred on the recording medium 8 may be controlled by regulating the protective particle layer 15A and ink receptive particle layer 16A to a desired thickness by the gaps between the charging blades 17B, 18B and the supply rolls 17A, 18A.

Herein, the structure of ink receptive particles 16 is secondary particles of a diameter of about 2 to 3 μm, preferably aggregated and granulated from fixing particles 16E and porous particles 16F between which gap 16G is formed, as shown in FIG. 2B, FIG. 5B, and FIG. 8B.

On the formed particle layer 16A, ink droplets 20A are ejected from ink jet recording heads 20 of individual colors driven by piezoelectric or thermal systems, and an image layer 16B is formed on the particle layer 16A. Ink droplets 20A ejected from the ink jet recording head 20 are loaded to the ink receptive particle layer 16A, and are promptly absorbed by gaps 16G formed between ink receptive particles 16, and the solvent is then sequentially absorbed in the pores of porous particles 16F and fixing particles 16E, and the pigment (coloring material) is trapped on the surface of primary particles (fixing particles 16E and porous particles 16F) forming the ink receptive particles 16.

At this time, gaps between primary particles forming the secondary particles function as a filter, and trap the pigment in the ink near the surface of the particle layer and by trapping and fixing on the primary particle surface, most of the pigment can be trapped near the surface of the ink receptive particle layer 16A.

In order to trap the pigment near the surface of ink receptive particle layer 16A on the surface of primary particles with certainty, it is possible to use a method whereby the ink and ink receptive particles 16 are made to react with each other, and the pigment promptly made insoluble (to aggregate).

After trapping of pigment, the ink solvent permeates in the depth direction of the particle layer, and is absorbed in the pores of porous particles 16F and fixing particles 16E, and is held in gaps 16G between particles. The fixing particles 16E absorbing the ink solvent are softened, and hence contribute to transfer and fixing.

Accordingly, advancing to next ink jet recording head 20, when ink droplets 20A of next color are ejected, mixing of inks and bleeding phenomenon can be suppressed.

At this time, the solvent or dispersion medium contained in the ink droplets 20A permeates into the particle layer 16A, however the recording material such as pigment is trapped near the surface of the particle layer 16A. That is, the solvent or dispersion medium may permeate to the back side of the particle layer 16A, however, the recording medium, such as pigment, does not permeate to the back side of the particle layer 16A. Hence, when transferred onto the recording medium 8, the particle layer 16C not permeated with the recording material, such as pigment, forms a layer on the image layer 16B. As a result, this particle layer 16C becomes a protective layer for sealing the surface of image layer 16B, and the coloring material, such as pigment, is not exposed to the surface, and so a tough image resistant to abrasion can be formed. The ink is preferred to be a pigment ink of concentration of about 10% or more, but it is not limited to pigment ink, and a dye ink may be also used.

On the other hand, in the second embodiment, since protective particles 15 do not receive ink, the solvent or dispersion medium contained in the ink droplets 20A does not permeate into the protective particle layer 15A.

Hence, when transferred onto the recording medium 8, the particle layer 16C and protective particle layer 15A, into which the recording material such as pigment does not permeate, form layers on the ink image layer 16B to be a protective layer for sealing the surface of ink image layer 16B (see FIG. 6B).

Thus, since the coloring material such as pigment is not exposed on the surface, a tough image resistant to abrasion can be formed. The ink is preferred to be a pigment ink of concentration of 10% or more, or it is not limited to a pigment ink, and a dye ink may be also used.

By successively transferring and/or fixing the protective particle layer 15A and ink receptive particle layer 16A onto the recording medium 8 from the intermediate transfer body 12, a color image is formed on the recording medium 8. The ink receptive particle layer 16A and protective particle layer 15A on the intermediate transfer body 12 are heated and pressurized by the transfer fixing device 22 heated by heating unit such as heater, and transferred onto the recording medium 8. Fixing by fixing particles 16E is carried out by adhesion between fixing particles 16E, or adhesion of fixing particles 16E and recording medium 8 by pressure and/or heat.

Protective particles 15 are also fused by heat, and integrated with ink receptive particle layer 16A.

At this time, by adjusting heating and pressing as mentioned below, the roughness of the image surface can be properly adjusted, and the degree of gloss can be controlled. Similar effects can also be obtained by cooling and peeling off.

After the peeling off the protective particle layer 15A and ink receptive particle layer 16A, residual particles 16D remaining on the surface of intermediate transfer body 12 are collected by the cleaning device 24 in FIG. 4, and the surface of intermediate transfer body 12 is charged again by the charging device 28, and the protective particle layer 15A and ink receptive particle layer 16A are formed.

In the third embodiment, further, the removing device 200 removes the ink receptive particles 16 in the regions other than the ink image layer 16B from the intermediate transfer body 12. At this time, the removal rate in the region other than the ink image layer 16B need not be 100%. Or only the upper layer may be removed and the lower layer may remain. This is because the ink receptive particles 16 in the region other than the ink image layer 16B become transparent after fixing, and do not cause any problem in image quality. Hence, removing unit of low removal rate may also be used.

The user is allowed to select whether or not to remove ink receptive particles 16 in the region other than the ink image layer 16B.

For example, as in a photographic image, when a uniform gloss is preferred in the entire area of non-image portion, particles may not be removed, or as in a case such as an image mainly composed of text, when a glossy image is not preferred, the particles may be removed.

Or, for example, the user can manipulate an operation panel (not shown) to select “gloss” or “non-gloss”.

Next, by transferring and/or fixing the particle layer 16A on which the ink image layer 16B is formed on the recording medium 8 from the intermediate transfer body 12, a color image is formed on the recording medium 8. The particle layer 16A on the intermediate transfer body 12 is heated and pressurized by the transfer fixing device 22 having a heating roller 22A heated by heating unit such as a heater, and transferred onto the recording medium 8. Fixing by fixing particles 16E is carried out by adhesion between fixing particles 16E, or adhesion of fixing particles 16E and recording medium 8 by pressure and/or heat.

At this time, by adjusting heating and pressing as mentioned below, the roughness of the image surface can be properly adjusted, and the degree of gloss can be controlled. Similar effects can be obtained by cooling and peeling off.

After peeling off particle layer 16A, residual particles 16D remaining on the surface of intermediate transfer body 12 are collected by the cleaning device 24, and the surface of intermediate transfer body 12 is charged again by the charging device 28, and the ink receptive particles 16 are supplied, and the ink receptive layer 16A is formed.

FIG. 3A, 3B, FIG. 6A, 6B and FIG. 9A, 9B show particle layers used in forming of images in the first to third embodiments of the invention.

As shown in FIG. 2A, FIG. 5A and FIG. 8A, on the surface of intermediate transfer body 12, a releasing layer 14A is formed to assure releasing property when transferring and to prevent adhesion inhibition of ink receptive particles 16 due to moisture adhesion to the surface.

In FIG. 2A and FIG. 8A, on the surface of intermediate transfer body 12, ink receptive particles 16 are formed as a uniform layer by the particle applying device 18. The particle layer 16A formed as mentioned above is preferred to be formed such that a thickness thereof corresponds to substantially three layers of ink receptive particles 16. By regulating the particle layer 16A to a desired thickness, the thickness of the particle layer 16A transferred onto the recording medium 8 is controlled. At this time, the surface of particle layer 16A is formed in a uniform thickness so as not to disturb image forming (forming of image layer 16B) by ejection of ink droplets 20A.

On the other hand, in FIG. 5A, on the surface of intermediate transfer body 12, a protective particle layer 15A is formed by the protective particle applying device 17. Further, an ink receptive particle layer 16A is formed by the ink receptive particle applying device 18. The protective particle layer 15A is preferred to be formed such that a thickness thereof corresponds to two layers of protective particles 15, and the ink receptive particle layer 16A is preferred to be formed such that a thickness thereof corresponds to three layers of ink receptive particles 16. By controlling the protective particle layer 15A and ink receptive particle layer 16A to a desired thickness, the thickness of the protective particle layer 15A and ink receptive particle layer 16A transferred on the recording medium 8 is controlled. At this time, the surface of ink receptive particle layer 16A is formed in a uniform thickness so as not to disturb image forming (forming of image layer 16B) by ejection of ink droplets 20A.

The recording material such as pigment contained in the ejected ink droplets 20A permeates into substantially one third to half of particle layer 16A as shown in FIG. 3A, FIG 6A and FIG. 9A, and a particle layer 16C into which recording material such as pigment has not permeated is remaining beneath it.

FIG. 9A shows a state that ink receptive particles 16 is removed in the regions other than ink image layer 16B by a removing device 200.

When formed on the recording medium by heating, pressing and transferring using the transfer fixing device 22, as shown in FIG. 3B, FIG. 6B and FIG. 9B, a particle layer 16C not containing recording material such as pigment remains on the ink image layer 16B (in FIG. 6B, particle layer 16C and protective particle layer 1SA), and these layers function as protective layers for the ink image layer 16B. Accordingly, the ink receptive particles 16, at least after fixing (in FIG. 6B, projective particles 15 and ink receptive particles 16), must be transparent.

The particle layer 16C (in the second embodiment, the protective particle layer 15A) is heated and pressurized by the transfer fixing device 22, and its surface can be made sufficiently smooth, and the degree of gloss of the image surface can be controlled by heating and pressing. That is, by controlling either the pressure or heat (or both) applied during transfer and fixing, it is possible to change the state of the surface on which the image layer 16B is formed on the ink receptive particle layer 16A transferred and fixed on the recording medium 8. By increasing the pressure or heat, the roughness of surface of ink receptive particle layer 16A (in the second embodiment, surface of protective particle layer 15A) is decreased, and the gloss is increased. By decreasing the pressure or heat, the surface of ink receptive particle layer 16A (in the second embodiment, surface of protective particle layer 15A) is not smoothed (remains rough), thereby the gloss is lowered, and a matte finish is obtained.

Further, drying of solvent trapped inside the ink receptive particles 16 may be promoted by heating.

The ink solvent received and held in the ink receptive particle layer 16A is also held in the ink receptive particle layer 16A after transferring and fixing, and is removed by natural drying, in the same way as drying of ink solvent in ordinary water-based ink jet recording. Accordingly, regardless of difference in ink permeability of recording medium 8, or in spite of being impermeable paper, an image of high quality can be formed at higher speed using water-based ink.

Through the above process, the image forming is completed. If residual particles 16D remaining on the intermediate transfer body 12 or foreign matter such as paper dust removed from the recording medium 8 are presented, after transfer of ink receptive particles 16 on the recording medium 8, they may be removed by the cleaning device 24.

When charging is repeated on the intermediate transfer body 12, the charging amount may not remain constant. In such a case, a neutralization apparatus 29 may be disposed at the downstream side of the cleaning device 24. Using a similar conductive roll as in the charging device 28, and an alternating-current voltage of approximately ±3 kV, 500 Hz is applied to the surface of intermediate transfer body 12 between the conductive roll and a driven roll 31 (grounded), and the surface of intermediate transfer body 12 can be neutralized.

The charging voltage, particle layer thickness, fixing temperature and other mechanical conditions are determined in optimum conditions depending on the composition of ink receptive particles 16 or ink, ink ejection volume, and the like, and hence desired effects can be obtained by optimizing each condition.

As shown in FIGS. 6A, 6B, in the second embodiment, the ink image layer 16B is covered with a protective layer consisting of particle layer 16B and protective particle layer 15A. However, the pigment (recording material) in the ink may fully permeate in the depth direction of ink receptive particle layer 16A, and the protective layer may be formed of protective particle layer 15A only. Since the protective particles 15 do not receive the ink, the ink does not permeate into the protective particle layer 15A. Hence, the ink image layer 16B can be protected and covered with the protective particle layer 15A.

A pattern forming apparatus according to a fourth embodiment of the invention is described below.

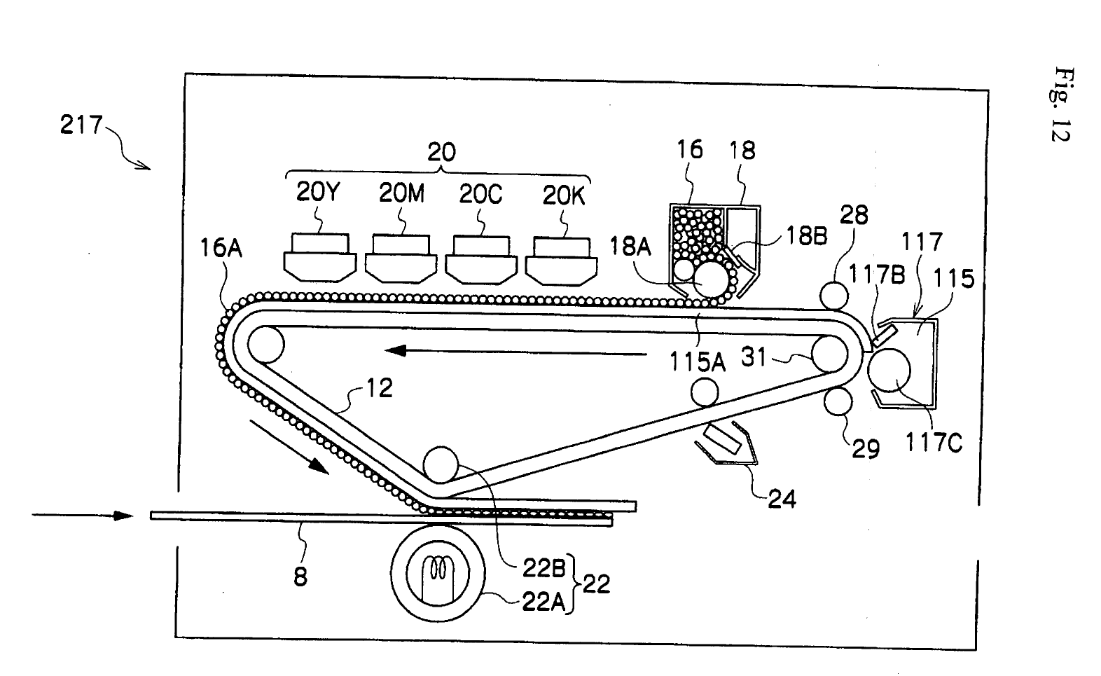

As shown in FIG. 12, a pattern forming apparatus 217 in the fourth embodiment comprises an endless belt-shaped intermediate transfer body 12, a charging device 28 for charging the surface of the intermediate transfer body 12, an ink receptive particle applying device 18 for forming an ink receptive particle layer 16A by applying and adhering ink receptive particles 16 in a uniform and specified thickness in a charged region on the intermediate transfer body 12, an ink jet recording head 20 for forming an ink image layer 16B (see FIG. 5A) by ejecting ink droplets 20A (see FIG. 5A) on the ink receptive particle layer 16A, and a transfer fixing device 22 for transferring and fixing an ink receptive particle layer on a recording medium 8 by overlapping the intermediate transfer body 12 with the recording medium 8, and by applying pressure and heat.

At the upstream side of the charging device 28, instead of the releasing agent applying device 14 (see FIG. 4), a protective agent applying device 117 is disposed for forming a protective agent layer 115A by applying a liquid protective agent 115 onto the intermediate transfer body.

The protective agent applying device 117 applies the protective agent 115 on the surface of intermediate transfer body 12 by an application roller 117C, and then, the layer thickness is regulated by a blade 117B.

The protective agent 115 is preferred to be low viscosity so as to be applied smoothly onto the intermediate transfer body 12. However, when the ink receptive particle layer 16A is formed after being applied, it is preferred to have high viscosity such that the ink receptive particles 16 are not be absorbed by capillary action, or to be elastic body. Additionally, when cooled after transferring and fixing process, it is required to be solidified at a specified hardness.

To satisfy these requirements, when applying by the protective agent applying device 117, the temperature of protective agent 115 is set higher to melt and apply at low viscosity, and when cooled in the process of moving after application, the viscosity is raised or elasticity is increased, the ink receptive particle layer 16A is formed, and for fixing, melted by heating and then fused and solidified at room temperature.

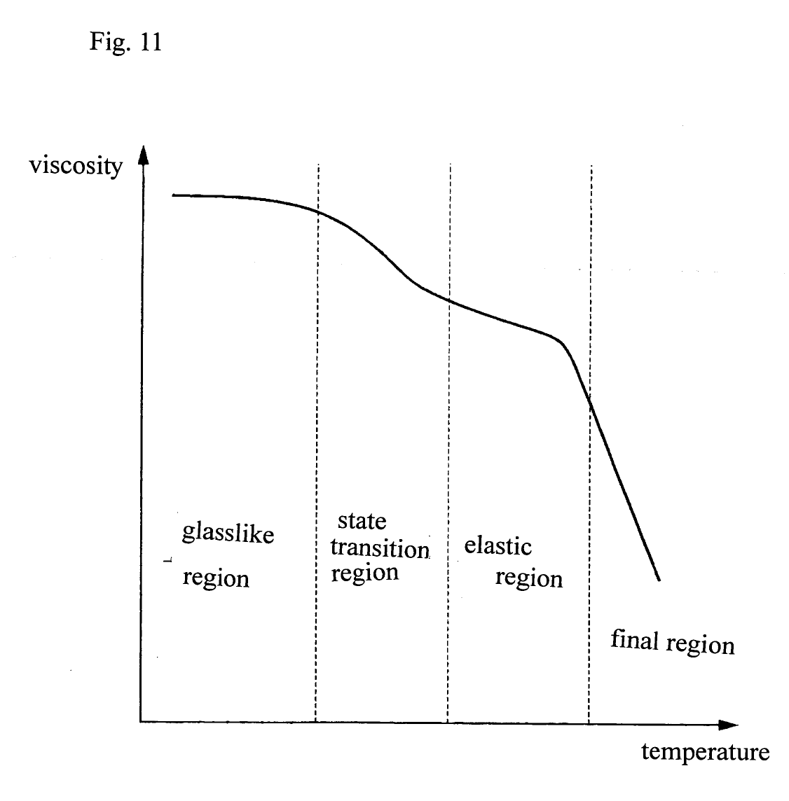

For example, a substance (protective agent 115) having properties as shown in graph in FIG. 11 may be used. That is, the protective agent 115 in the protective agent applying device 117 is raised to the temperature of the final region (liquid state), and the protective agent 115 is used as a low viscosity liquid (like a glue), and is applied to the intermediate transfer body 12. After being applied, it is cooled while the intermediate transfer body 12 is rotatably moved, and the temperature is lowered to that in an elastic region, and an ink receptive particle layer 16A is formed at the point of being elastic body. While maintaining the state of the elastic body, the ink receptive particle layer proceeds to a process of transfer and fixing and is transformed into a liquid state again by heating and is made smooth. When lowered to a temperature of the grasslike region before being discharged, as a proper hardness as protective layer is obtained.

Substance having such properties includes waxes.

Examples of wax include polyethylene wax, polypropylene wax, fatty acid amide wax, and alkylene bis-fatty acid wax.

Specific examples of the wax include polyolefins of low molecular weight such as polyethylene, polypropylene, and polybutene; silicones having softening point by heating; fatty acid amides such as oleic amide, erucic amide, ricinoleic amide, and stearic amide; vegetable wax such as ester wax, carnauba wax, rice wax, candelilla wax, Japan wax, and jojoba oil; animal wax such as beeswax; mineral or petroleum wax such as montan wax, ozokerite, ceresin, paraffin wax, microcrystalline wax, and Fischer-Tropsch wax; and modifications thereof.

In this method of applying the protective layer in liquid form, as compared with an electrostatic adhesion method conducted in forming of the protective layer in particles form (see the second embodiment), the protective layer forming process is simplified, and the uniformity of the layer thickness formed is improved. Besides, since the wax has a releasing property, it is not required to form a releasing layer 14A by a releasing agent applying device 14.

Instead of the protective particles 15 of the second embodiment, protective particles containing wax in binding resin may be used. By using protective particles containing wax, it is not required to form a releasing layer 14A by a releasing agent applying device 14. Although not shown in the diagram, this structure is similar to FIG. 4, except that the releasing agent applying device 14 is eliminated. This structure is called a modified example of the second embodiment.

Such protective particles may be obtained by containing wax in the above protective particles 15, or wax may be contained in polyester resin or the like.

Composition and preparation of protective particles having wax contained in bonding resin are nearly the same in the toner used on image forming apparatus of an electrophotographic system. The so-called oil-less toner that does not require application of releasing agent such as oil in the fixing device of an image forming apparatus of electrophotographic system is even closer to the protective particles in the embodiment. An example of compositions and preparation of oil-less toner is disclosed in Japanese Patent Application Laid-Open (JP-A) No. 7-333904.

A first modified example of the third embodiment is described below.

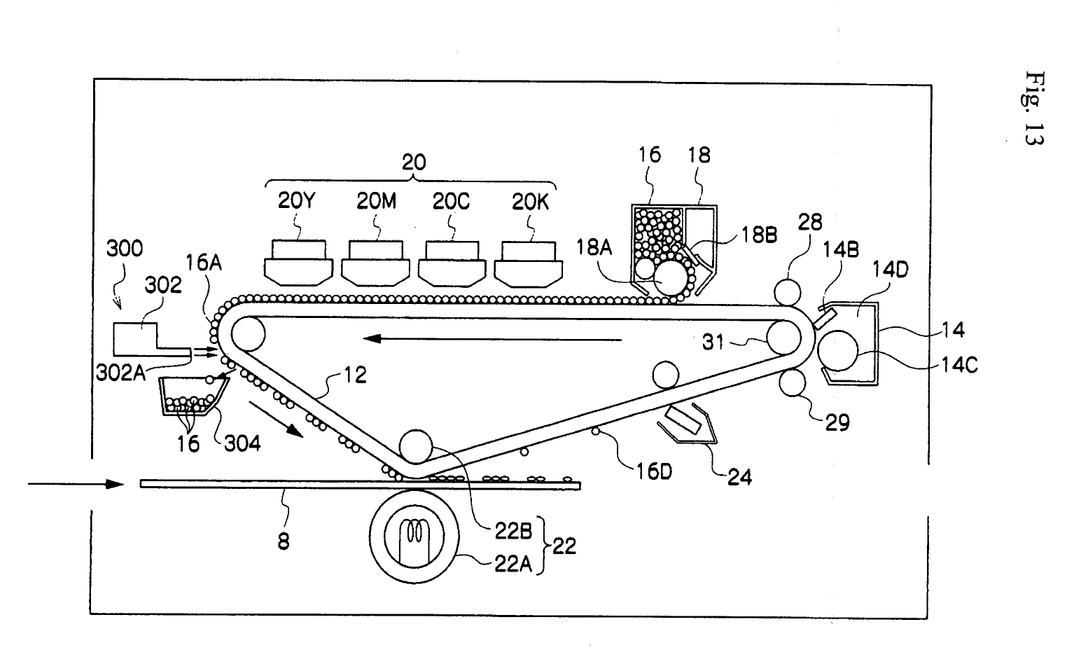

In the first modified example shown in FIG. 13, a removing device 300 includes a blowing device 302 for blowing air from a nozzle 302A into the ink receptive particle layer 16A. By this blowing device 302, air is blown to the entire surface of the ink receptive particle layer 16A, and ink receptive particles 16 are blow away from the region other than the ink image layer 16B.

By setting the air blowing force for blowing away the ink receptive particles 16 larger than the adhesion force of ink receptive particles 16 to the intermediate transfer body 12 in the region other than the ink image layer 16B, and smaller than in the ink image layer 16B, the ink receptive particles 16 only can be removed from the region other than the ink image layer 16B.

The removed ink receptive particles 16 are caught and collected by a recovery box 304. The collected ink receptive particles 16 may be directly returned to the particle applying device 18, or may be returned to a supply tank (not shown) for supplying ink receptive particles into the particle applying device 18, and can be recycled.

A second modified example of third embodiment is described below.

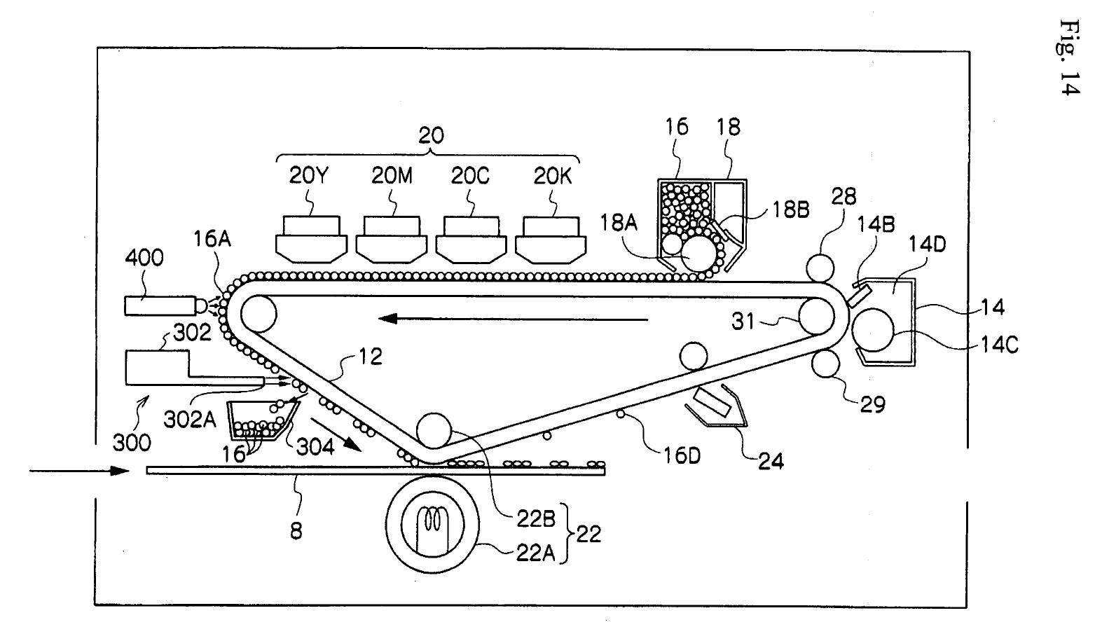

In the second modified example shown in FIG. 14, at the upstream side of removing device 300 of the first modified example, and at the downstream side of ink jet recording head 20, plural LEDs 400 are provided as infrared irradiating device for illuminating infrared rays to ink receptive particle layer 16A.

Because the ink image layer 16B is colored, it has a high absorption rate of infrared rays, however the region other than the ink image layer 16B has low absorption rate. Therefore, if the entire surface of ink image layer 16A is exposed to infrared rays, only the ink image layer 16B is highly elevated in temperature. Therefore, only the ink image layer 16B is solidified and fixed temporarily. As a result, between the ink image layer 16B and the region other than the ink image layer, there is a large difference in adhesion force to the intermediate transfer body 12 (the adhesion force in the ink image layer 16B is larger).

Therefore, the ink receptive particles 16 only in the region other than the ink image layer 16B can be removed with certainty.

Although not shown, at the upstream side of the removing device 200 in the third embodiment, a plurality of LEDs 400 may be provided as infrared irradiating device for exposing ink receptive particle layer 16A to infrared rays.

Infrared rays may be emitted by other units than LEDs 400.

The temperature elevating device for raising the temperature in the region of ink image layer 16B is not limited to an infrared irradiating device.

For example, by irradiating electromagnetic waves (microwaves) like electromagnetic oven, moisture molecules in the region of ink image layer 16B may be oscillated to generate heat.

Herein, “temporary fixing” is fixing to such an extent that can be transferred without problem in the next process.

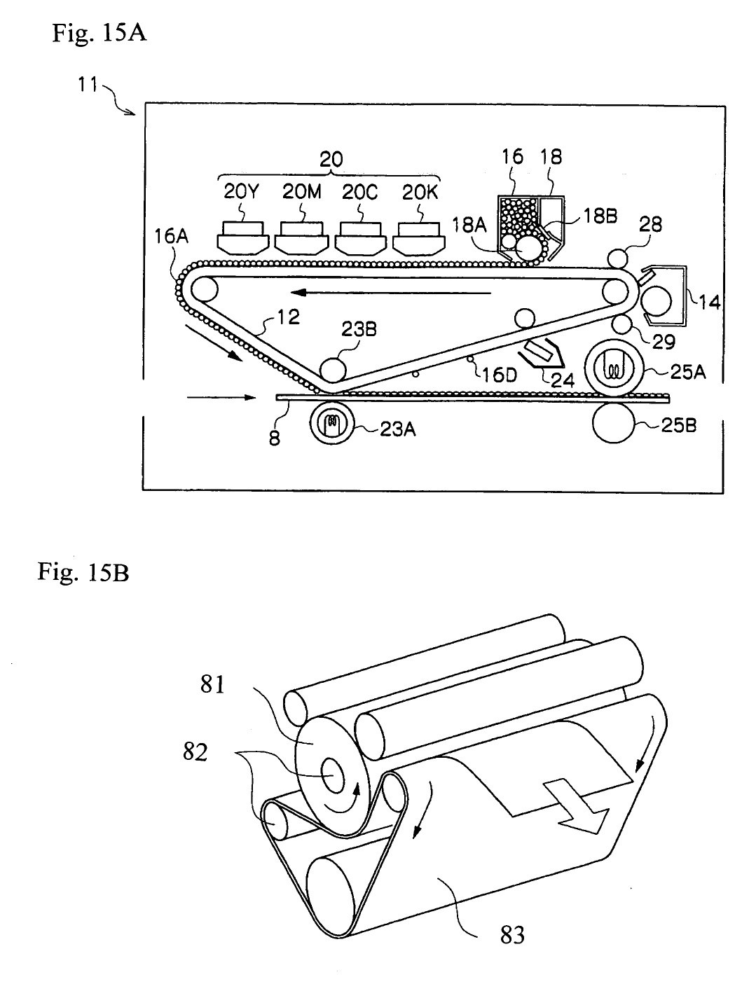

In the pattern forming apparatus, in the first to third embodiments, the transfer fixing device can be arranged by separating it into the transfer device and the fixing device. Corresponding embodiments are shown as fifth to seventh embodiments in FIGS. 15A, 15B, FIGS. 16A, 16B, and FIGS. 17A, 17B.

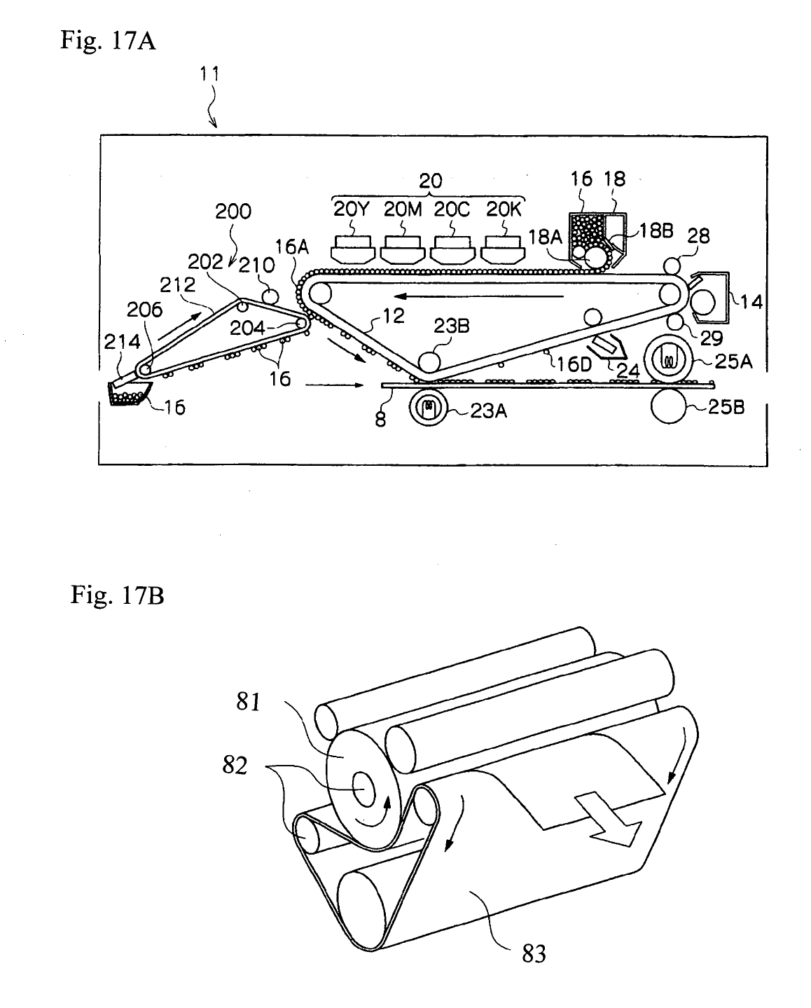

In the fifth and seventh embodiments, as shown in FIG. 15A and FIG. 17A, a pattern forming apparatus 11 comprises an endless belt-shaped intermediate transfer body 12, a charging device 28 for charging the surface of the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets on the particle layer, a transfer device 23 for transferring an ink receptive particle layer 16A on the recording medium 8 by overlapping the intermediate transfer body 12 with a recording medium 8, and by applying pressure and heat, and a fixing device 25 for fixing the ink receptive particle layer 16A on the recording medium 8.

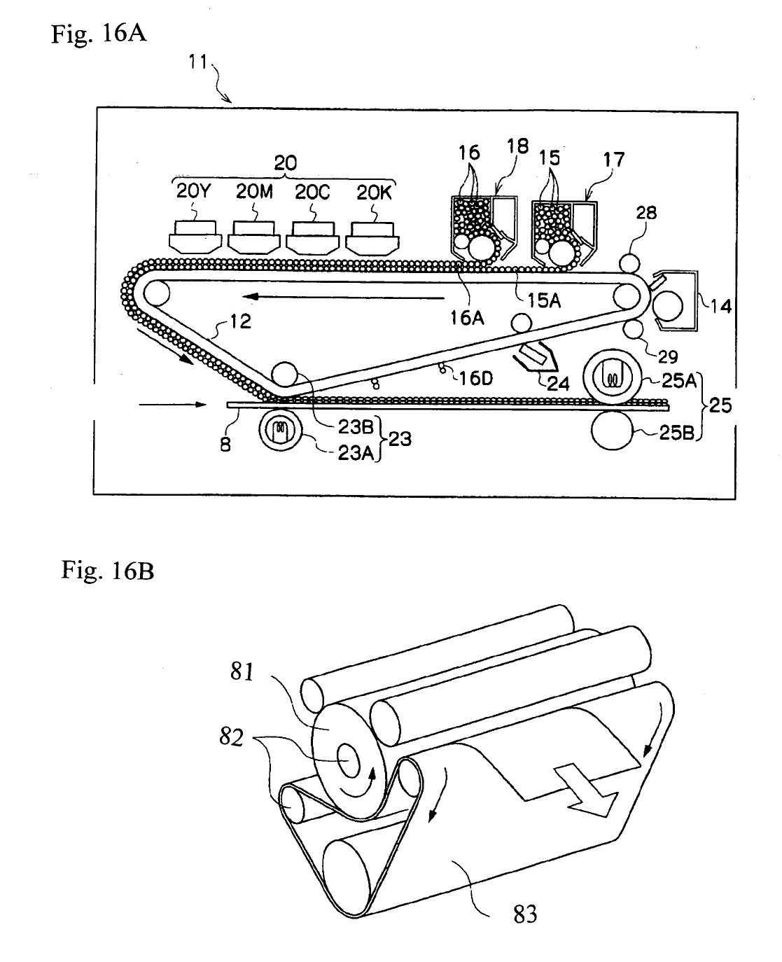

In the sixth embodiment, as shown in FIG. 16A, a pattern forming apparatus 11 comprises an endless belt-shaped intermediate transfer body 12, a charging device 28 for charging the surface of the intermediate transfer body 12, a protective particle applying device 17 for forming a protective particle layer 15A by applying and adhering protective particles 15 in a uniform and specified thickness in a charged region on the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets on the particle layer, a transfer device 23 for transferring an ink receptive particle layer 16A onto the recording medium 8 by overlapping the intermediate transfer body 12 with a recording medium 8, by applying pressure and heat, and a fixing device 25 for fixing the ink receptive particle layer 16A on the recording medium 8.

More specifically, the ink receptive particle layer 16A on the intermediate transfer body 12 (in the sixth embodiment, the protective particle layer 15A and ink receptive particle layer 16) is nipped between the transfer roller 23A of the transfer device 23 and the driven roller 23B, which are opposite position and between which the intermediate transfer body 12 is placed, and transferred onto the recording medium 8 together with the image layer 16B.

Then, the ink receptive particle layer 16A transferred onto the recording medium 8 (in the sixth embodiment, the protective particle layer 15A and ink receptive particle layer 16) is nipped between the fixing device 25 and the driven roller 25B, which are opposite position and between which the recording medium 8 is placed, and fixed on the recording medium 8.

Thus, by separating into an image transfer operation and fixing operation, the image fixing property can be enhanced without sacrificing print speed. By the secondary fixing operation, pressure in the transfer process can be lowered, and the load on the intermediate transfer body 12 and transfer device 23 can be lessened.

Further, by separating into an image transfer operation and fixing operation, it is easier to control the pressure and heating, and it is also becomes easy to control the characteristics of the surface of protective particle layer 15A and the surface of ink receptive particle layer 16A after being transferred on the recording medium 8, and the gloss (surface glossiness) can be controlled more smoothly.

Further, as the structure of fixing device 25, it is easier to select a belt nip system capable of extending the nip area, as shown in FIG. 15B, FIG. 16B and FIG. 17B. In FIG. 15B, FIG. 16B and FIG. 17B, reference numeral 81 is a heat roll, 82 is a heating lamp, and 83 is a belt.

In the seventh embodiment, too, the removing device 300 of the first modified example of the third embodiment can also be applied. Or, as in the second modified example, at the upstream side of the removing device 300 and at the downstream side of the ink jet recording head 20, infrared rays may be irradiated to the entire surface of the ink receptive particle layer 16A by LEDs 400, and the ink image layer 16B may be temporarily fixed.

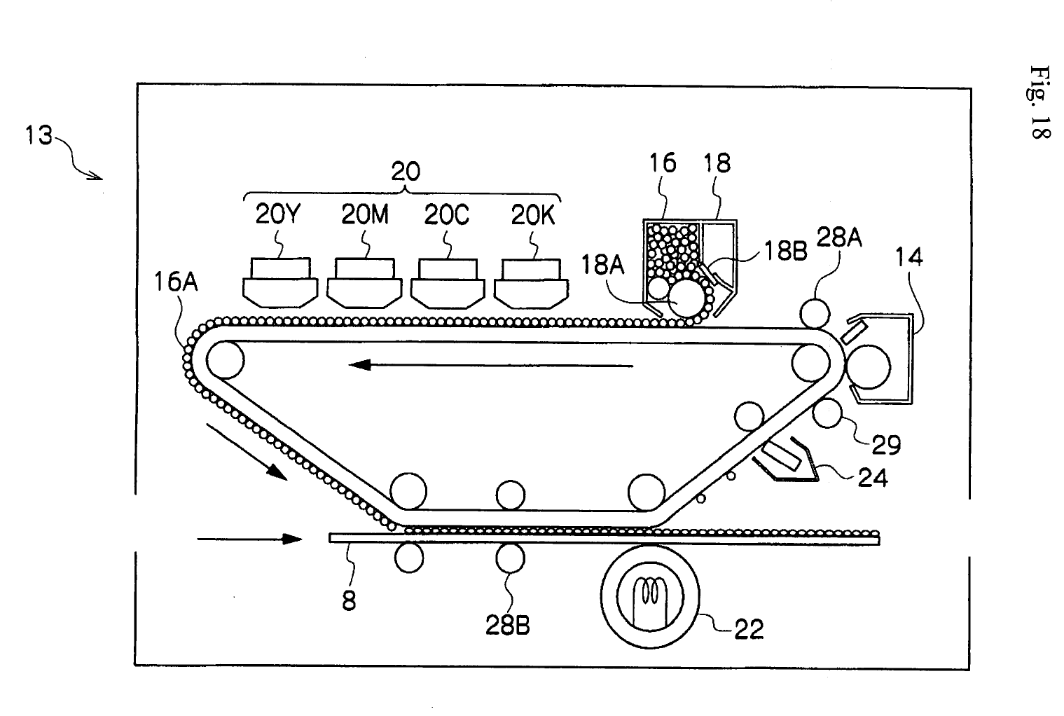

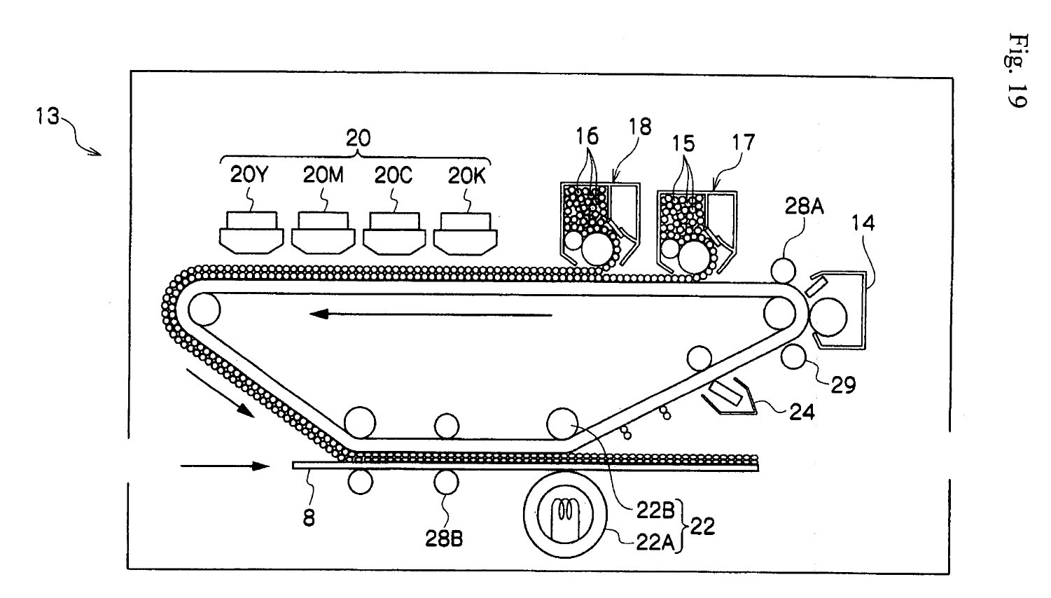

The pattern forming apparatus may also include a charging device at the back side of the recording medium 8 (the reverese side of the image forming surface) before the transfer fixing process in the first and second embodiment. Eighth and ninth embodiments of the invention are shown in FIG. 18 and FIG. 19, respectively.

In the eighth embodiment, as shown in FIG. 18, a pattern forming apparatus 13 comprises an endless belt-shaped intermediate transfer body 12, a charging device 28A for charging the surface of the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets onto the particle layer, a charging device 28B for charging the back side, that is, the non-image forming side of the recording medium 8, and a transfer fixing device 22 for transferring an ink receptive particle layer 16A onto the recording medium 8 by overlapping the intermediate transfer body 12 with a recording medium 8, and by applying pressure and heat.

In the ninth embodiment, as shown in FIG. 19, a pattern forming apparatus 13 comprises an endless belt-shaped intermediate transfer body 12, a charging device 28A for charging the surface of the intermediate transfer body 12, a protective particle applying device 17 for forming a protective particle layer 15A by applying and adhering protective particles 15 in a uniform and specified thickness in a charged region on the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets onto the particle layer, a charging device 28B for charging the back side, that is, the non-image forming side of the recording medium 8, and a transfer fixing device 22 for transferring an ink receptive particle layer 16A onto the recording medium 8 by overlapping the intermediate transfer body 12 with a recording medium 8, and by applying pressure and heat.

Since non-image area of ink receptive particle layer 16A is free from ink, the fixing particles 16E are not softened by the ink solvent, and in the first embodiment, it is transferred by adding heat together with pressure, when transferring to the recording medium 8 at the transfer fixing portion 22.

The current ninth embodiment is characterized by transferring the ink receptive particles 16 in the non-image area, adsorbed electrostatically onto the surface of intermediate transfer body 12, before the transfer fixing process electrostatically onto the surface of recording medium 8, by applying voltage from the back side of the recording medium 8.

Since the ink receptive particles 16 of the ink image layer 16B have absorbed the ink, they are transferred and fixed onto the side of recording medium 8 when pressed. However, since the ink receptive particle layer 16A of the non-image portion is electrostatically adsorbed to the intermediate transfer body 12, it is difficult to transfer in that state. Accordingly, to transfer the ink receptive particle layer 16A in the non-image portion, the ink receptive particle layer 16A on the surface of intermediate transfer body 12 is adhered to the recording medium 8, and an electric field is formed between the recording medium 8 and particles to transfer by electrostatic force.

Specifically, by using a conductive roll 28B, an electric charge of reverse polarity of the ink receptive particles 16 is applied directly to the back side of the recording medium 8 to transfer the ink receptive particles to the recording medium 8. Or an electric charge may be applied by a corotron.

Further, the ink image layer 16B absorbs moisture in the ink, and therefore, is provided with flexibility, and by pressing the ink image layer 16B placed between the intermediate transfer body 12 and recording medium 8, it is transferred to the recording medium 8. Here, in order to transfer the particles of the ink image layer 16B, the ink receptive particles 16 may be heated to above the glass transition point by a heating device to carry out the transfer.

Herein, by applying the electrostatic transfer technology of electrophotography, transfer onto the surface of recording medium 8 can be carried out by applying a voltage of reverse polarity to the charging polarity of ink receptive particles 16 by a conductive roller (charging device 28B in the embodiment). At this time, it is possible to apply sufficient voltage for forming an electric field for peeling off the ink receptive particles 16 electrostatically adsorbed onto the surface of intermediate transfer body 12.

Since the applied voltage and other mechanical conditions are determined by the ink receptive particles 16 (in the ninth embodiment, protective particles 15 and ink receptive particles 16) or intermediate transfer body 12, by optimizing each condition, desired results may be obtained. By the above configuration, the transfer efficiency of ink receptive particles 16 (and protective particles 15) in the non-image portion can be enhanced.

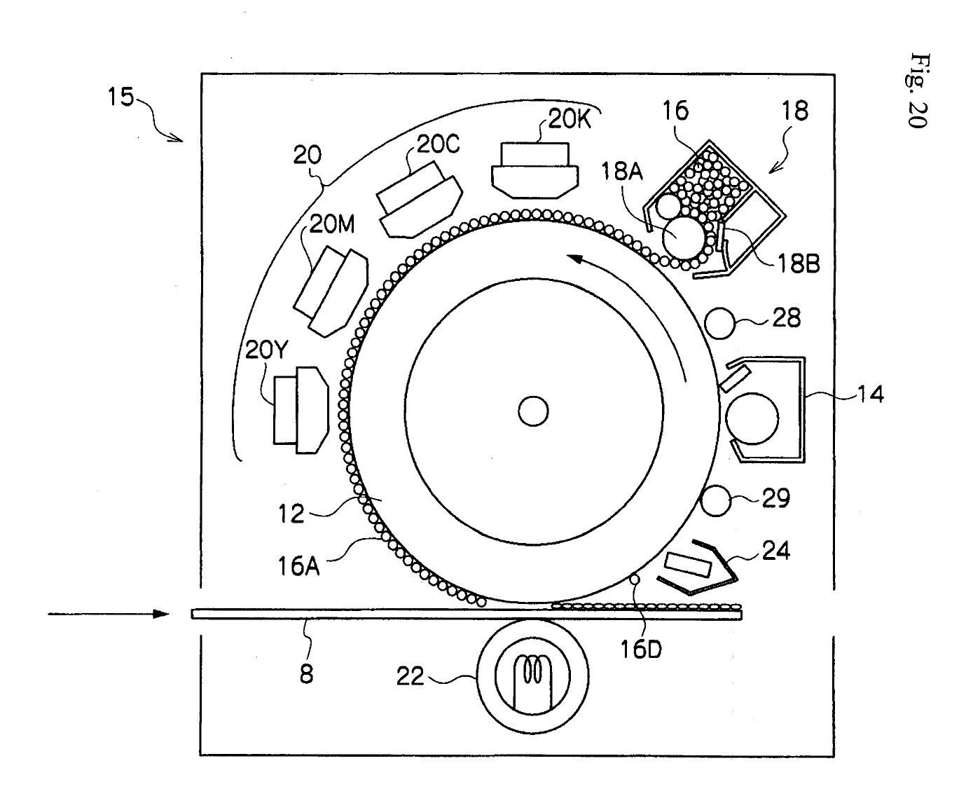

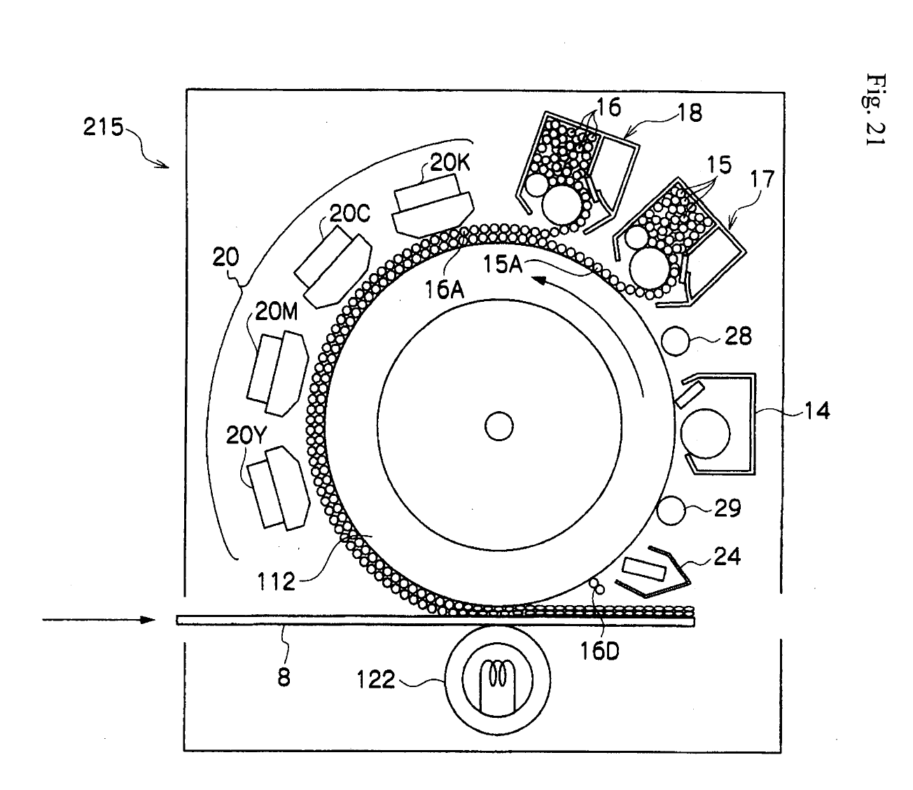

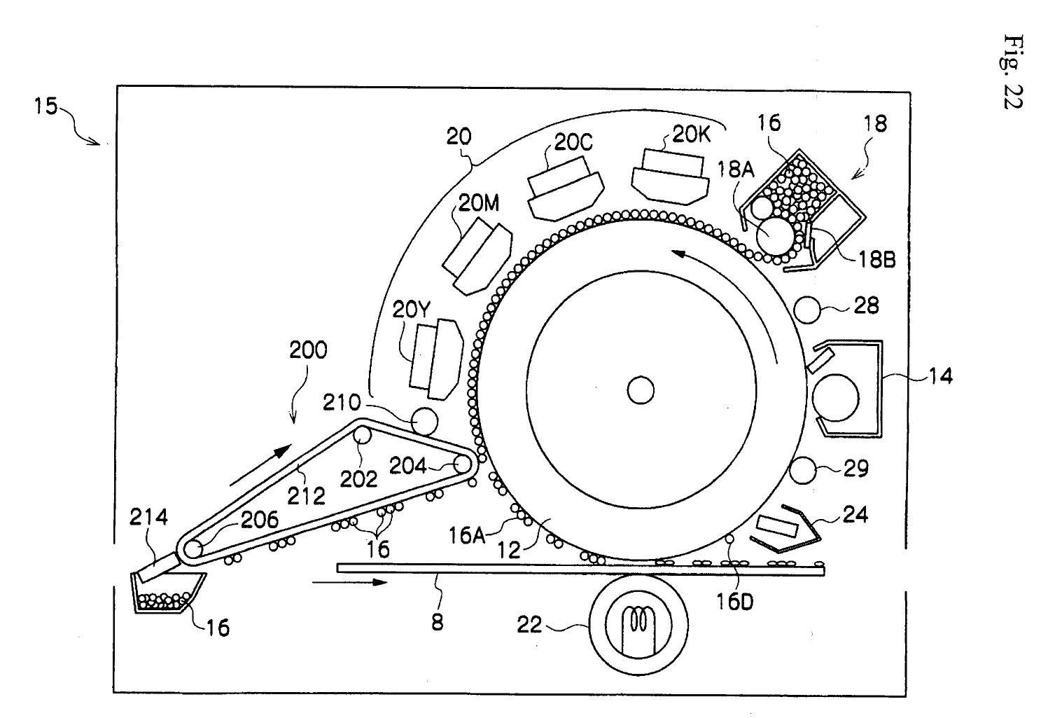

In the pattern forming apparatus, the belt type intermediate transfer body 12 in the first to third embodiments may be replaced by an intermediate transfer drum. Its configuration is shown as tenth to twelfth embodiments in FIG. 20, FIG. 21 and FIG. 22 respectively.

In the tenth embodiment, as shown in FIG. 20, a pattern forming apparatus 15 comprises an intermediate transfer body 12 in a drum shape, a charging device 28 for charging the surface of the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets onto the particle layer, and a transfer fixing device 22 for transferring and fixing an ink receptive particle layer onto the recording medium 8 by overlapping the intermediate transfer body 12 with a recording medium 8, and by applying pressure and heat.

In the eleventh embodiment, as shown in FIG. 21, a pattern forming apparatus 215 comprises an intermediate transfer body 12 in a drum shape, a charging device 28 for charging the surface of the intermediate transfer body 12, a protective particle applying device 17 for forming a protective particle layer 15A by applying and adhering protective particles 15 in a uniform and specified thickness in a charged region on the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets onto the particle layer, and a transfer fixing device 122 for transferring and fixing an ink receptive particle layer onto the recording medium 8 by overlapping the intermediate transfer body 12 with a recording medium 8, and by applying pressure and heat.

In the intermediate transfer body 12 of this embodiment, a conductive substrate of aluminum or aluminum alloy having the surface treated by anodic oxidation is used. As the aluminum alloy, aluminum/magnesium alloy, aluminum/titanium alloy or the like may be used. The surface of these materials is preferably finished to a mirror smooth surface in order to form a uniform layer of anodic oxide film.

Anodic oxidation is preferably carried out under the conditions of voltage of 5 to 500 V and current density of 0.1 to 5 A/dm², in an acidic bath of chromic acid, sulfuric acid, oxalic acid, boric acid or phosphoric acid. Thickness of anodic oxide film is preferred to be about 2 to 50 μm, or more preferably about 5 to 15 μm. An anodic oxidation surface is often porous, however since a porous surface is chemically unstable, it is preferably treated by hydration pore sealing by using boiling water or steam.

In this embodiment, the mirror finished surface of aluminum pipe is anodically oxidized in sulfuric acid at a current density of 1.5 A/dm², and an anodic oxide film of 7 μm is formed, and sealed by boiling water.

As an intermediate transfer body 12, the drum is more rigid as compared with the belt, and it is easier to keep a specified distance between the nozzle surface of the ink jet recording head 20 and the surface of intermediate transfer body 12. In the case of multipass recording specific to ink jet recording, for enhancing the image quality by dividing the recorded image at plural times, as compared with the belt, the drum is advantageous from the viewpoint of assurance of repeated recording position precision.

In the tenth embodiment, too, the removing device 300 of the first modified example in the third embodiment can also be applied. Or, as in the second modified example, at the upstream side of the removing device 300 and at the downstream side of the ink jet recording head 20, infrared rays may be irradiated to the entire surface of the ink receptive particle layer 16A by LEDs 400, and the ink image layer 16B may be temporarily fixed.

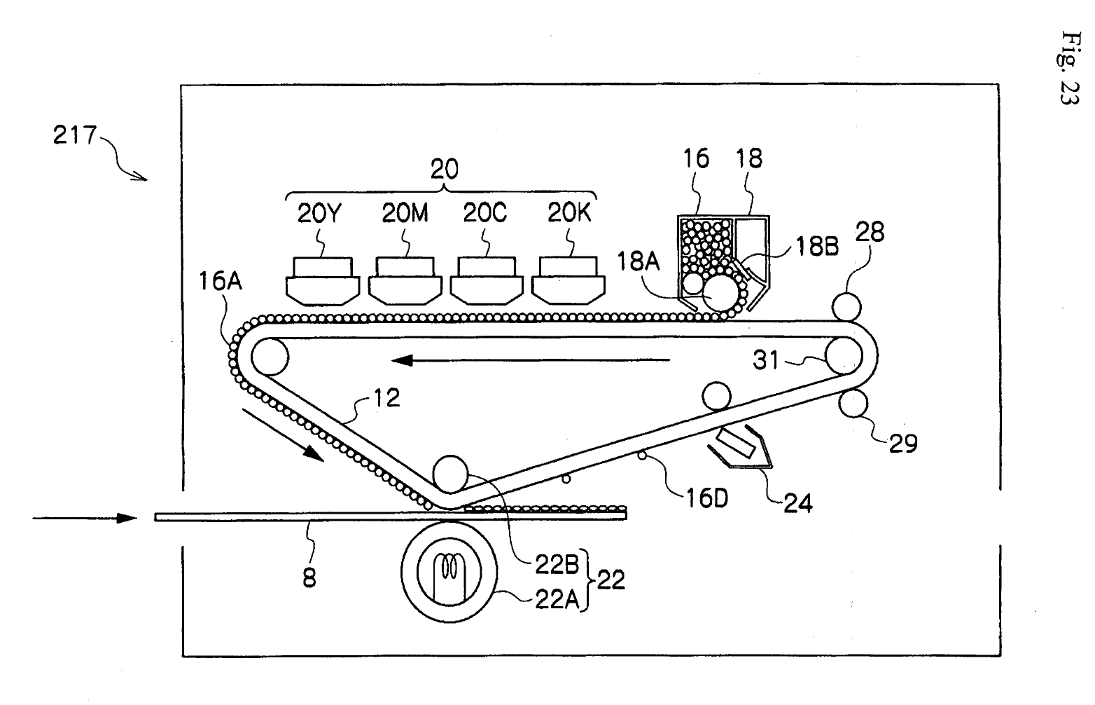

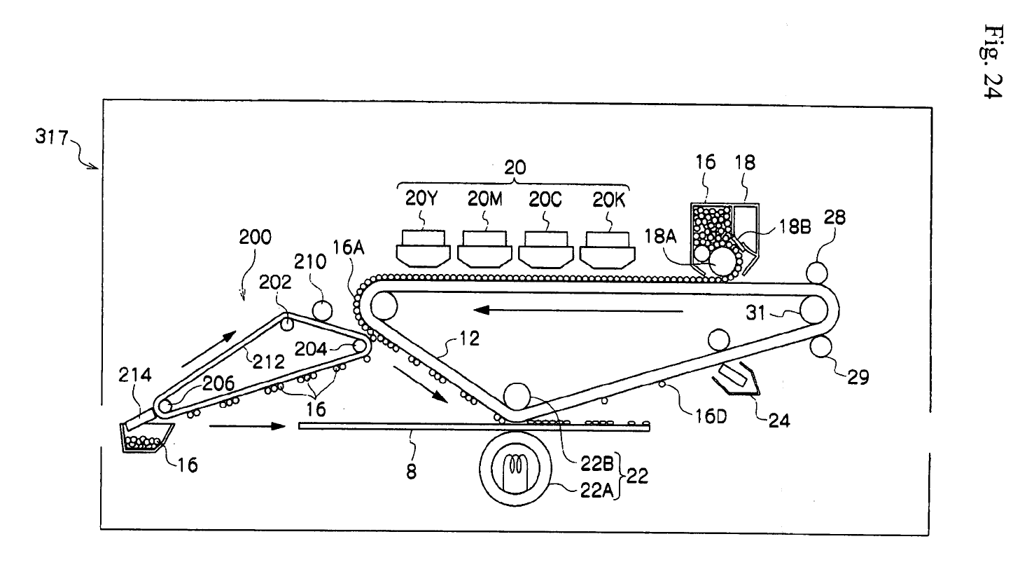

FIG. 23 and FIG. 24 show pattern forming apparatuses of thirteenth and fourteenth embodiments of the invention.

As shown in FIG. 23 and FIG. 24, a pattern forming apparatus (217 or 317) in the embodiments comprises an endless belt-shaped intermediate transfer body 12, a charging device 28 for charging the surface of the intermediate transfer body 12, a particle applying device 18 for forming a particle layer by applying and adhering ink receptive particles 16 in a uniform and specified thickness in a charged region on the intermediate transfer body 12, an ink jet recording head 20 for forming an image by ejecting ink droplets onto the particle layer, and a transfer fixing device 22 for transferring and fixing an ink receptive particle layer onto the recording medium 8 by overlapping the intermediate transfer body 12 with a recording medium 8, and by applying pressure and heat. These pattern forming apparatuses have the configuration that the releasing agent applying device 14 is omitted from the structure of the first and third embodiments (FIG. 1 and FIG. 7).

In the embodiments, it is configured that the surface of intermediate transfer body 12 is formed as a releasing layer (releasing material). As the intermediate transfer body 12, a surface layer of tetrafluoroethylene-perfluoroalkyl vinyl ether copolymer of 400 μm in thickness is formed on a base layer of urethane material of 2 mm in thickness.

Since the surface layer has a releasing property from the ink receptive particles 16, when transferring and fixing, the ink receptive particle layer is transferred efficiently from the intermediate transfer body to the recording medium. Moreover, since the surface layer has a releasing property and also a water repellent property, ink solvent permeating into the ink receptive particle layer does not adhere to the surface of intermediate transfer body 12, and is held in the ink receptive particles 16, and transferred to the recording medium 8. That is, the ink solvent does not remain on the surface of intermediate transfer body 12, and there is no adverse effect on supply of ink receptive particles 16 and others. Hence it is not required to form a releasing layer by applying releasing agent, which contributes to simplification, miniaturization, and low cost.

<Constituent Elements>

Constituent elements in the respective embodiments of the invention are specifically described below.

Unless otherwise specified in the embodiments, in principle, the following constituent elements are used.

<Ink Receptive Particles>

Ink receptive particles used in the embodiments of the invention are specified as follows.

Ink receptive particles in the embodiments of the invention receive the ink. By, the property, “ink receptive” it is meant the ability to retain at least part of the ink components (at least a liquid component). The ink receptive particles in the embodiments of the invention have a trap structure for trapping at least a liquid component of the ink, and contain a liquid absorbing resin.

When the ink receptive particles in the embodiments of the invention receive the ink (ink receiving method), first the ink adheres to the ink receptive particles, and at least a liquid components of the ink is trapped by the trap structure. At this time, the recording material, whether it is a pigment or dye of the ink components, is adhered to the ink receptive particle surface or is trapped by the trap structure. The trapped liquid components of the ink are absorbed by the liquid absorbing resin. Thus, the ink receptive particles receive the ink. The ink receptive particles receiving the ink are transferred on the recording medium, and the image is recorded.

Trapping of ink liquid components by this trap structure is physical capturing by particle wall structure, and it is very fast as compared with absorbing of liquid by liquid absorbing resin, and the ink receptive particles receiving the ink can be transferred to various recording media in a short time, whether the medium is permeable or impermeable. Moreover, since the trapped liquid components of the ink are absorbed by the liquid absorbing resin, and the retention stability improves, and so at the time of transfer, the ink receptive particles have received the ink do not allow liquid components to leak out or bleed if physical force is applied.

Therefore, even when using various types of ink, recording is possible with various recording media at high speed and with high image quality.

Moreover, since ink receptive particles are transferred onto the recording medium with the ink liquid components completely trapped, curling or cockling of the recording medium, or lowering of the strength of recording medium, due to liquid absorption can be prevented.

After transfer of ink receptive particles, the liquid absorbing resin functions as a binder resin or coating resin for recording material, and the fixing property and the fixing property (rubbing resistance) of recorded matter can be enhanced, and the gloss of recorded matter can be controlled. Further, not depending on whether the recording material is pigment or dye, high color formation can be obtained.

Conventionally, in order to improve the fixing property (rubbing resistance) for ink (for example, pigment ink) when used insoluble components, dispersed particles such as pigment as recording material, a large amount of polymer must be added to the ink. However, when a large amount of polymer is added to the ink (including treatment liquid), the nozzle of the ink ejecting unit may clog and reliability is decreased. In embodiments of the invention, by contrast, since the liquid absorbing resin functions as such polymer, high image quality, high fixing property, and high reliability of the system can all be satisfied.

Herein, the “trap structure” is a physical particle wall structure for retaining at least liquid, and examples thereof include a void structure, recess structure or capillary structure. Accordingly, as mentioned above, trapping of ink liquid components by the trap structure is much faster than liquid absorption by a liquid absorbing resin. The maximum diameter of openings (apertures) in these structures is preferred to be 50 nm to 5 μm, or more preferably 300 nm to 1 μm. In particular, the maximum diameter of openings is preferred to be large enough to trap the recording material, for example, the pigment of volume average particle diameter of 100 nm, for example. However, together with these, fine pores of less than 50 nm in the maximum diameter of openings may also be provided. From the viewpoint of improvement of liquid absorbing property, voids, capillary, or the like preferably may communicate with each other inside the particles.

It is desirable that the trap structure traps not only the liquid components from the ink components but also the recording material. Together with the ink liquid components, when the recording material, in particular, pigments are trapped in the trap structure, the recording material is retained and fixed within the ink receptive particles without being unevenly distributed, to achieve both high speed recording and high image quality at the same time. Ink liquid components are mainly ink solvents (dispersion media: vehicle liquid).

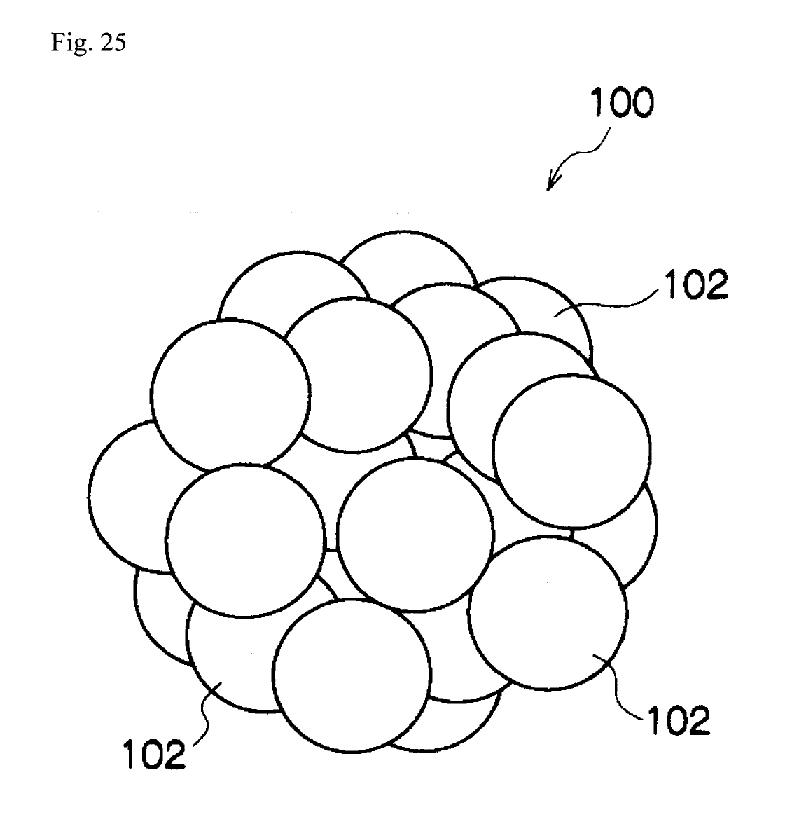

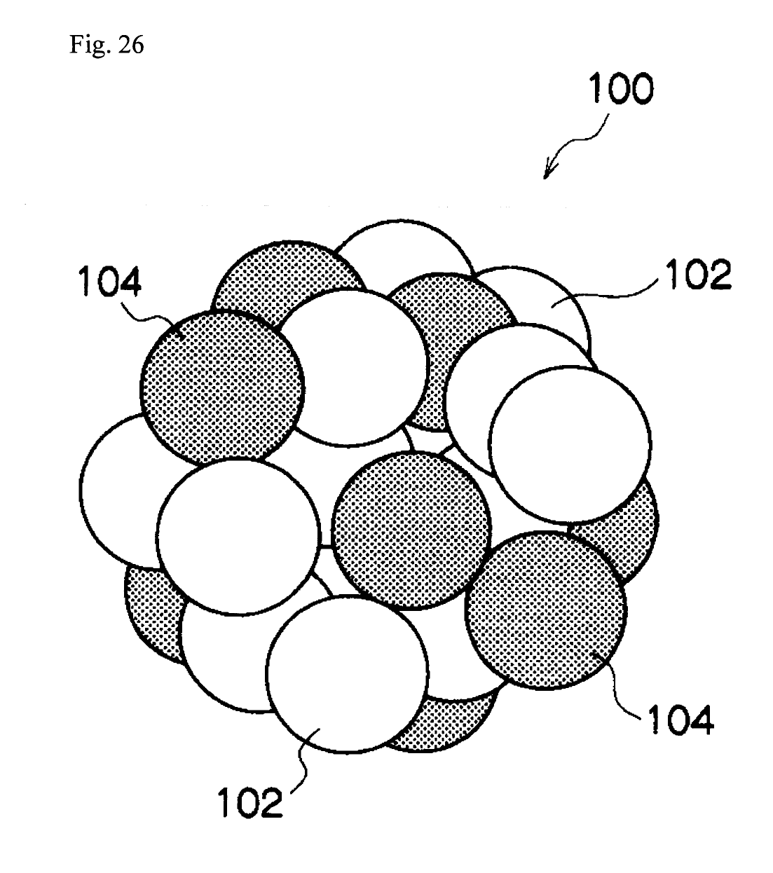

Ink receptive particles in the embodiments of the invention may preferably be, for example, composite particles 100, in which particles 102 of liquid absorbing resin are aggregated as shown in FIG. 25, in order to provide the trap structure as mentioned above. Further, to improve the liquid absorbing property of ink liquid components, ink receptive particles in the embodiments of the invention are particularly preferred to be composite particles 100 in which inorganic particles 104, in addition to particles 102 of liquid absorbing resin, are aggregated as shown in FIG. 26, because water absorbing property, charging and conductive properties and other functions can be conferred. In these composite particles, a void structure can be formed by gaps between particles.

The volume average particle size of liquid absorbing resin particles is preferred to be 50 nm to 10 μm, more preferably 0.1 μm to 5 μm, and still more preferably 0.2 μm to 2 μm. The volume average particle size of inorganic particles is preferred to be 10 nm to 30 μm, more preferably 50 nm to 10 μm, and still more preferably 0.1 μm to 5 μm. The particles of liquid absorbing resin and inorganic particles may be either primary particles or aggregates by agglomeration of primary particles.

These composite particles are obtained, for example, by agglomerating particles in a semi-sintered state. A semi-sintered state is a state in which some of the granule shape remains and voids are retained between particles. When an ink liquid component is trapped in the trap structure, part of the composite particles may be dissociated, that is, composite particles may be broken up, and particles composing the composite particles may be scattered.

The inorganic particles include colorless, pale color, white particles, or the like, and specific examples thereof include colloidal silica, alumina, calcium carbonate, zinc oxide, titanium oxide, tin oxide, and the like. These inorganic particles may be surface treated (partial hydrophobic treatment, introduction of specific functional group, etc.). In the case of silica, for example, a hydroxyl group in silica is treated with a silylating agent such as trimethyl chlorosilane or t-butyl dimethyl chlorosilane to introduce an alkyl group. Then dehydrochlorination takes place by silylating agent and reaction progresses. When an amine is added to this reaction system, hydrochloric acid is transformed into hydrochloride, and therefore, reaction is promoted. The reaction can be controlled by regulating the treating amount or treating conditions of a silane coupling agent having an alkyl group or phenyl group as a hydrophobic group, or a coupling agent such as titanate system or zirconate system. Similarly, surface treatment can also be carried out by using aliphatic alcohols, higher fatty acids, or derivatives thereof. Further, for the surface treatment, a coupling agent having a cationic functional group such as a silane coupling agent having quaternary ammonium salt structure, (substituted) amino groups, or the like, silane, a coupling agent having fluorine functional group such as fluorosilane, and other coupling agents having anionic functional group such as carboxylic acid may be used. In particular, inorganic particles are porous and are preferred from the viewpoint of affect of the liquid absorbing property on the ink receptive particles.

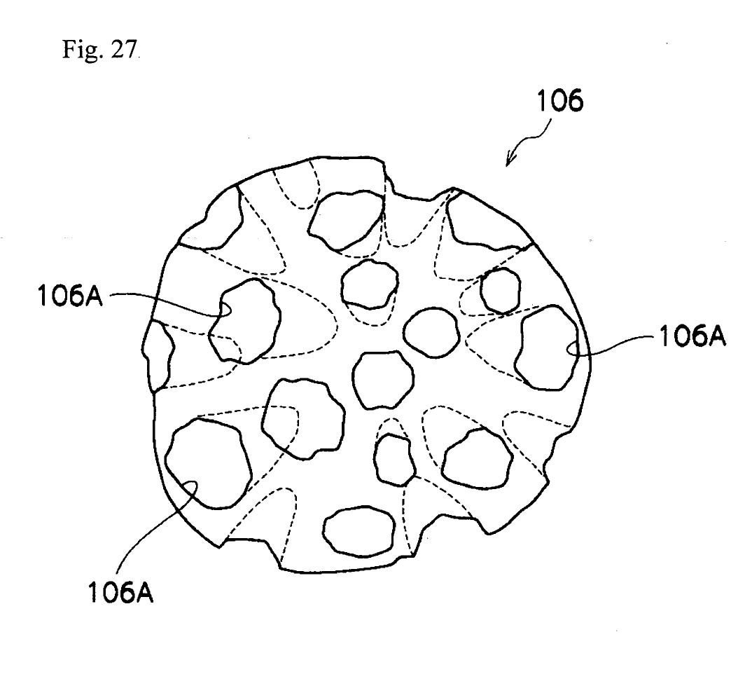

Ink receptive particles of the embodiments of the invention, if having trap structure such as void structure, recess structure or capillary structure, may be composed of particles 106 of liquid absorbing resin having a recess 106A (for example, with maximum aperture diameter of 100 nm or more, preferably 200 nm to 2000 nm) on the surface as shown in FIG. 27, which are obtained, for example, by lost wax method or obtained by solidifying and crushing molten resin or dissolved resin containing bubbles inside by injection of gas or incorporation of foaming agent. However, the most preferred example is composite particles obtained by the above agglomeration method.

Particle size of ink receptive particles of the embodiments of the invention is preferred to be 0.5 μm to 60 μm, more preferably 1 μm to 30 μm, or still more preferably 3 μm to 15 μm, in average spherical equivalent diameter. The average spherical equivalent diameter is determined as follows. Optimum method depends on particle size, however, for example, a method that particle size is determined by applying a light scattering principle to a dispersion of the particles in a liquid, or a method that particle size is determined by image processing for a projected image of particles, or other methods may be used. Examples which can be given of generally used methods include a Microtrack UPA method (trade name) or Coulter counter method.

The liquid absorbing liquid will be explained hereinafter. In the liquid absorbing resin, since the absorbed ink liquid component (for example, water-based solvent) acts as a plasticizer of resin (polymer), it is softened and the fixing property is improved. Accordingly, the ink receptive particles can be transferred (fixed) on plain paper as a recording medium only by pressing (however, for improving the gloss of recorded matter, heating and pressing may be effective). However, if absorbing liquid is too much to be swollen, bleeding may occur and fixing property decreases, and therefore, the liquid absorbing resin is preferred to be a resin that absorbs liquid weakly (hereinafter, called as “weak liquid absorbing resin”). The weak liquid absorbing resin is, for example, when absorbing water as liquid, a hydrophilic resin capable of absorbing liquid from several percent (approximately 5 percent) to several hundreds of percent (approximately 500 percent) relative to mass of the resin, preferably approximately 5% to 100%.

If the liquid absorbing property is less than approximately 5%, the liquid trapped in the voids may flow out from the voids at the time of.transferring (or fixing), and the image quality deteriorates. Besides, since the plasticization of resin is insufficient, a greater energy is needed for fixing. To the contrary, if the liquid absorbing capacity is too high, not only liquid absorption, but also moisture absorption is active, and therefore, dependence of ink receptive particles on handling environment is higher, and it may be hard to use. For example, by crosslinking the resin at high degree, it is possible to avoid mutual fusion of particles if absorbing moisture (for example, commercial water absorbing resin). In such a case, however, it may be hard to fix on the recording medium. In the case of weak liquid absorbing resin, since the liquid absorbing speed of resin is considerably slower than in the strong liquid absorbing resin, it is an important point in designing of structure and properties of ink receptive particles so as to trap the liquid in the void structure initially, and then absorb liquid in the resin.

From such point of view, the liquid absorbing resin is composed of, for example, a homopolymer of a hydrophilic monomer, or a copolymer composed of both a hydrophilic monomer and a hydrophobic monomer. The copolymer is preferred for obtaining a weak water absorbing resin. In addition to the monomers, graft copolymers or block copolymers may be used by copolymerizing a unit of polymer/oligomer structure as a starting material with other unit.

Examples of the hydrophilic monomer include monomers including —OH; -EO unit (ethylene oxide group); —COOM wherein, M is, for example, a hydrogen, an alkaline metal such as Na, Li, K, or the like, an ammonia, an organic amine, or the like; —SO3M (M is, for example, a hydrogen, an alkaline metal such as Na, Li, K, or the like, an ammonia, an organic amine, or the like); —NR3 wherein, R is H, alkyl, phenyl, or the like; NR4X wherein, R is H, alkyl, phenyl, or the like, and X is a halogen, a sulfate radical, acidic anions such as a carboxylic acid, BF4, or the like. Specific examples of the hydrophilic monomer include 2-hydroxy ethyl methacrylate, 2-hydroxy ethyl acrylate, acrylamide, acrylic acid, methacrylic acid, unsaturated carboxylic acid, crotonic acid, and maleic acid, and the like. Examples of a hydrophilic unit or monomer include cellulose derivatives such as cellulose, ethyl cellulose, carboxy methyl cellulose, or the like; polymerizable carboxylates such as starch derivatives, monosaccharides, polysaccharides, vinyl sulfonic acid, styrene sulfonic acid, acrylic acid, methacrylic acid, (anhydrous) maleic acid, or the like or (partially) neutralized salts thereof; vinyl alcohols; vinyl pyrrolidone, vinyl pyridine, amino(meth)acrylate or dimethyl amino(meth)acrylate derivatives, or onium salts thereof; amides such as acrylamide, isopropyl acrylamide, or the like; vinyl compounds containing polyethylene oxide chain; vinyl compounds containing hydroxyl group; polyesters composed of multifunctional carboxylic acid and polyhydric alcohol; especially branched polyesters having trifunctional or higher acids such as trimellitic acid and containing plural carboxylic acids or hydroxyl groups at the end portion; polyesters having polyethylene glycol structure, and the like.

The hydrophobic monomers are monomers having a hydrophobic group, and specific examples thereof include olefin (tyrene, butadiene, or the like), styrene, alpha-methyl styrene, alpha-ethyl styrene, methyl methacrylate, ethyl methacrylate, butyl methacrylate, acrylonitrile, vinyl acetate, methyl acrylate, ethyl acrylate, butyl acrylate, lauryl methacrylate, and the like. Examples of a hydrophobic unit or monomer include styrene derivatives such as styrene, alpha-methyl styrene, vinyl toluene; polyolefins such as vinyl cyclohexane, vinyl naphthalene, vinyl naphthalene derivatives, alkyl acrylate, phenyl acrylate, alkyl methacrylate, phenyl methacrylate, cycloalkyl methacrylate, alkyl crotonate, dialkyl itaconate, dialkyl maleate, polyethylene, ethylene/vinyl acetate, polypropylene or the like; and derivatives thereof.

Specific examples of liquid absorbing resin composed of copolymers of the hydrophilic monomer and the hydrophobic monomer include olefin polymers (or its modifications, or products into which a carboxylic acid unit is introduced by copolymerization, or the like) such as (meth)acrylate, styrene/(meth)acrylic acid/(anhydrous) maleic acid copolymer, ethylene/propylene, or the like, branched polyester enhanced in acid value by trimellitic acid or the like, polyamide, and the like.

Preferably, the liquid absorbing resin has a structure of neutralized salt (for example, carboxylic acid, or the like). The neutralized salt structure such as carboxylic acid can form an ionomer by interaction with a cation (for example, a monovalent metal cation such as Na, Li or the like), when absorbing ink containing the corresponding cation and thus, the fixing strength of final recorded matter improves. Moreover, the neutralized salt structure such as carboxylic acid promotes the aggregation of recording materials (for example, pigment or dye) having an anionic group and hence the image quality is also improved.

Preferably, the liquid absorbing resin contains a substituted or unsubstituted amino group, or a substituted or unsubstituted pyridine group. Such groups have a bactericidal effect or interaction with a recording material having anion group (for example, pigment or dye), and therefore, the image quality and fixing property are enhanced.

In the liquid absorbing resin, the molar ratio (the hydrophilic monomer: the hydrophobic monomer) of the hydrophilic unit (hydrophilic monomer) and the hydrophobic unit (hydrophobic monomer) is preferably 5:95 to 70:30, more preferably 7:93 to 60:40, still more preferably 10:90 to 50:50. In particular, the hydrophilic unit is preferably 7 to 70 mol % relative to the total amount of the liquid absorbing resin, more preferably 10 to 50 mol %. If the amount of the hydrophilic monomer is within the above range, the water absorbing speed and water absorbing amount are improved when the ink receptive particles absorb water-based liquid, and the handling performance of receptive particles in environments of high humidity to low humidity and balance of transfer and fixing property can be established.

The liquid absorbing resin may be straight chain structure or branched chain structure, preferably, the liquid absorbing resin is branched structure. The liquid absorbing resin may be non-crosslinked or low-crosslinked. The liquid absorbing resin may be random copolymers or block copolymers of the straight chain structure, or may be more preferably polymers of branched structure including random copolymers, block copolymers and graft copolymers of branched structure. For example, in the case of polyesters synthesized by polycondensation, when the end group is increased by branched structure, it is easier to extend the control latitude of hydrophilic property, water absorbing property, and handling ability and fixing property of particles. Regardless of addition polymerization system or polycondensation system, when a carboxylic group is placed on the branched portion, supply of the cation from ink enable a final formation of a firmly fixed image having an ion crosslinking type. Such branched structure can be obtained by one of the popular techniques, that is, a trace (for example, less than 1%) of a crosslinking agent such as divinyl benzene or di(meth)acrylate is added at the time of synthesizing, or a large amount of an initiator is added together with the crosslinking agent. It is to be noted that fixing of recorded image may be difficult or energy required for fixing may be increased when forming a three-dimensional network by enhancing the crosslinking degree of the liquid absorbing resin like a commercial water absorbing resin. To assure the fixing property, even though a crosslinking reaction takes place, it is required to adjust so that the thermoplasticity is maintained sufficiently on the entire structure, while be kept in part.

The absorbing liquid may be ion-crosslinked by ions supplied from ink. When introducing a unit having carboxylic acid into the liquid absorbing resin, the strength of resin image after fixing tends to be higher. Examples of the unit having carboxylic acid include such as copolymers having a carboxlic acid such as (meth)acrylic acid or maleic acid, a (branched) polyesters having a carboxylic acid, and the like. It is estimated that ion crosslinking or acid-base interaction occurs between a carboxylic acid in the resin and alkaline metal cation, alkaline earth metal cation, organic amine.onium cation, or the like, which is supplied from liquid such as water-based ink, thereby reinforcing the fixed image.

When the liquid absorbing resin contains a polar group, it is preferred from a viewpoint of enabling hydrophilic property, and charging and conductive properties. The polar group contributing to hydrophilic property is the same as that for the hydrophilic monomer. Examples of the polar group include hydroxylic group, ethylene oxide group, carboxylate group, and amino group. The polar group contributing to charging and conductive properties is preferably a salt forming structure such as (substituted) amino group, (substituted) pyridine group or its amine salt, quaternary ammonium salt, and the like for positive charging, or is preferably an organic acid (salt) structure such as carboxylic acid (salt), sulfonic acid (salt), and the like for negative charging. It is further effective to add a charging regulator for electrophotographic toner such as a salt forming compound of quaternary ammonium salt of low molecular weight, organic borate, salicylic acid derivative, and the like, to the liquid absorbing resin. For controlling the conductivity, it is effective to add conductive or semiconductive inorganic materials such as tin oxide, titanium oxide, or the like.

The liquid absorbing resin is preferred to be a noncrystalline resin, and its glass transition temperature (Tg) is preferably 40 to 90 deg. C., or more preferably 50 to 70 deg. C. When the glass transition temperature is within this range, the particle handling property, image blocking property, and imaging fixing property are satisfied at the same time. The glass transition temperature (and melting point) is determined from the major maximum peak measured in accordance with ASTMD 3418-8, the disclosure of which is incorporated herein by reference. The major maximum peak can be measured by using DSC-7 (manufactured by Perkin Elmer). In this apparatus, temperature of detection unit is corrected by melting point of indium and zinc, and the calorimetric value is corrected by fusion heat of indium. For the sample, an aluminum pan is used, and for the control, an empty pan is set. Measurement is carried out at an elevated rate of temperature of 10 deg. C./min.

The weight-average molecular weight of the liquid absorbing resin is preferably 3,000 to 300,000, or more preferably 10,000 to 100,000. When the weight-average molecular weight is within this range, quick liquid absorption, fixing at a low energy, and strength of image after fixing can be satisfied at the same time. The weight-average molecular weight is measured under the following conditions. For example, the GPC is HLC-8120GPC, SC-8020 (manufactured by TOSOH CORPORATION), the column is two pieces of TSK gel, SuperHM-H (manufactured by TOSOH CORPORATION, 6.0 mm ID×15 cm), and the eluent is THF (tetrahydrofuran). The conditions of experiment is as follows: sample concentration of 0.5%, flow velocity of 0.6 ml/min, sample injection amount of 10 μl, measuring temperature of 40 deg. C., and IR detector. Calibration curve is prepared from ten samples of polystyrene standard samples TSK standards (manufactured by TOSOH CORPORATION), A-500, F-1, F-10, F-80, F-380, A-2500, F-4, F-40, F-128, and F-700.

Acid value of the liquid absorbing resin is 50 to 1000 as expressed by carboxylic acid groups (—COOH), preferably 150 to 500, more preferably 50 to 500, or still more preferably 100 to 300. When the acid value is within this range, it is possible to control the handling and water absorbing properties of particles and fixing property. The acid value as expressed by carboxylic acid groups (—COOH) is measured as follows.

The acid value is measured by a neutralization titration method in accordance with JIS K 0070 (the disclosure of which is incorporated herein by reference). That is, a proper amount of sample is prepared, and to this sample, 100 ml of solvent (diethyl ether/ethanol mixture) is added together with several droplets of indicator (phenolphthalein solution). Then, the resulting mixture is stirred and mixed sufficiently in a water bath until the sample is dissolved completely. The solution is titrated with 0.1 mol/L of potassium hydroxide ethanol solution, and an end point is determined when a pale scarlet color of indicator continues for 30 seconds. Acid value (A) is calculated by the following equation:
A=(B×f×5.611)/S
wherein, A represents acid value, S is the sample amount (g), B is the amount (ml) of 0.1 mol/L of potassium hydroxide ethanol solution used in titration, and f is a factor of 0.1 mol/L of potassium hydroxide ethanol solution.

Other additives for the ink receptive particles in the embodiments of the invention will be described below. The ink receptive particles in the embodiments of the invention are preferred to contain components for aggregating or thickening ink components. When such components are contained, recording materials (for example, pigment or dye) contained in ink are aggregated or polymers are thickened, and therefore, the image quality and fixing property are improved.

Components having such functions may be contained as functional groups, or as compound in the water absorbing resin. Examples of such functional group include carboxylic acid, polyhydric metal cation, polyamine, and the like.

Preferred examples of such compound include aggregating agent such as inorganic electrolyte, organic acid, inorganic acid, organic amine, and the like.

Examples of the inorganic electrolyte includes an alkali metal ion such as a lithium ion, a sodium ion, a potassium ion, a polyvalent metal ion such as an aluminum ion, a barium ion, a calcium ion, a copper ion, an iron ion, a magnesium ion, a manganese ion, a nickel ion, a tin ion, a titanium ion and a zinc ion, hydrochloric acid, hydrobromic acid, hydriodic acid, sulfuric acid, nitric acid, phosphoric acid, thiocyanic acid, and an organic carboxylic acid such as acetic acid, oxalic acid, lactic acid, fumaric acid, citric acid, salicylic acid and benzoic acid, and organic sulfonic acid salts.

Specific examples of the inorganic electrolyte include an alkali metal salt such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate, and a polyvalent metal salt such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartrate, calcium lactate, calcium fumarate, calcium citrate, copper chloride, copper bromide, copper sulfate, copper nitrate, copper acetate, iron chloride, iron bromide, ion iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate.

Examples of the organic acid include arginine acid, citric acid, glycine, glutamic acid, succinic acid, tartaric acid, cysteine, oxalic acid, fumaric acid, phthalic acid, maleic acid, malonic acid, lycine, malic acid, compounds represented by Formula (1), and derivatives of the compounds.

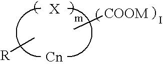

In the Formula (1), X represents O, CO, NH, NR₁, S or SO₂. R₁ represents an alkyl group and R₁ is preferably CH₂, C₂H₅ and C₂H₄OH. R represents an alkyl group and R is preferably CH₂, C₂H₅ and C₂H₄OH. R may be or may not be included in the Formula. X is preferably CO, NH, NR and O, and more preferably. CO, NH and O. M represents a hydrogen atom, an alkali metal or amines. M is preferably H, Li, Na, K, monoethanol amine, diethanol amine or triethanol amine, is more preferably H, Na, or K, and is further preferably a hydrogen atom. n represents an integer of 3 to 7. n is preferably such a number that a heterocyclic ring is a six-membered ring or five-membered ring, and is more preferably such a number that the heterocyclic ring is a five-membered ring. m represents 1 or 2. A compound represented by the Formula (1) may be a saturated ring or an unsaturated ring when the compound is the heterocyclic ring. 1 represents an integer of 1 to 5.

Specific examples of the compound represented by the Formula (1) include the compound having any of furan, pyrrole, pyrroline, pyrrolidone, pyrone, thiophene, indole, pyridine, and quinoline structures, and furthermore, having a carboxyl group as a functional group. Specific examples of the compound include 2-pyrrolidone-5-carboxylic acid, 4-methyl-4-pentanolido-3-carboxylic acid, furan carboxylic acid, 2-benzofuran carboxylic acid, 5-methyl-2-furan carboxylic acid, 2,5-dimethyl-3-furan carboxylic acid, 2,5-furan dicarboxylic acid, 4-butanolido-3-carboxylic acid, 3-hydroxy-4-pyrone-2,6-dicarboxylic acid, 2-pyrone-6-carboxylic acid, 4-pyrone-2-carboxylic acid, 5-hydroxy-4-pyrone-5-carboxylic acid, 4-pyrone-2,6-dicarboxylic acid, 3-hydroxy-4-pyrone-2,6-dicarboxylic acid, thiophene carboxylic acid, 2-pyrrole carboxylic acid, 2,3-dimethyl pyrrole-4-carboxylic acid, 2,4,5-trimethyl pyrrole-3-propionic acid, 3-hydroxy-2-indole carboxylic acid, 2,5-dioxo-4-methyl-3-pyrroline-3-propionic acid, 2-pyrrolidine carboxylic acid, 4-hydroxyproline, 1-methylpyrrolidine-2-carboxylic acid, 5-carboxy-1-methyl pyrrolidine-2-acetic acid, 2-pyridine carboxylic acid, 3-pyridine carboxylic acid, 4-pyridine carboxylic acid, pyridine dicarboxylic acid, pyridine tricarboxylic acid, pyridine pentacarboxylic acid, 1,2,5,6-tetrahydro-1-methyl nicotinic acid, 2-quinoline carboxylic acid, 4-quinoline carboxylic acid, 2-phenyl-4-quinoline carboxylic acid, 4-hydroxy-2-quinoline carboxylic acid, and 6-methoxy-4-quinoline carboxylic acid.

Preferable examples of the organic acid includes citric acid, glycine, glutamic acid, succinic acid, tartaric acid, phthalic acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, or derivatives or salts thereof. The organic acid is more preferably pyrrolidone carboxylic acid, pyrone carboxylic acid, pyrrole carboxylic acid, furan carboxylic acid, pyridine carboxylic acid, coumalic acid, thiophene carboxylic acid, nicotinic acid, or derivatives or salts thereof. The organic acid is further preferably pyrrolidone carboxylic acid, pyrone carboxylic acid, furan carboxylic acid, coumalic acid, or derivatives or salts thereof.

An organic amine compound may be any of a primary amine, secondary amine, tertiary amine, quaternary amine or salts thereof. Specific examples of the organic amine compound include a tetraalkyl ammonium, alkylamine, benzalconium, alkylpyridium, imidazolium, polyamine and derivatives or salts thereof. Specific examples of the organic amine include amyl amine, butyl amine, propanol amine, propyl amine, ethanol amine, ethyl ethanol amine, 2-ethyl hexyl amine, ethyl methyl amine, ethyl benzyl amine, ethylene diamine, octyl amine, oleyl amine, cyclooctyl amine, cyclobutyl amine, cyclopropyl amine, cyclohexyl amine, diisopropanol amine, diethanol amine, diethyl amine, di-2-ethylhexyl amine, diethylene triamine, diphenyl amine, dibutyl amine, dipropyl amine, dihexyl amine, dipentyl amine, 3-(dimethyl amino)propyl amine, dimethyl ethyl amine, dimethyl ethylene diamine, dimethyl octyl amine, 1,3-dimethyl butyl amine, dimethyl-1,3-propane diamine, dimethyl hexyl amine, amino butanol, amino propanol, amino propane diol, N-acetyl amino ethanol, 2-(2-amino ethyl amino)-ethanol, 2-amino-2-ethyl-1,3-propane diol, 2-(2-amino ethoxy)ethanol, 2-(3,4-dimethoxy phenyl)ethyl amine, cetyl amine, triisopropanol amine, triisopentyl amine, triethanol amine, trioctyl amine, trityl amine, bis(2-aminoethyl) 1,3-propane diamine, bis(3-aminopropyl)ethylene diamine, bis(3-aminopropyl) 1,3-propane diamine, bis(3-amino propyl)methyl amine, bis(2-ethyl hexyl)amine, bis(trimethyl silyl)amine, butyl amine, butyl isopropyl amine, propane diamine, propyl diamine, hexyl amine, pentyl amine, 2-methyl-cyclohexyl amine, methyl-propyl amine, methyl benzyl amine, monoethanol amine, lauryl amine, nonyl amine, trimethyl amine, triethyl amine, dimethyl propyl amine, propylene diamine, hexamethylene diamine, tetraethylene pentamine, diethyl ethanol amine, tetramethyl ammonium chloride, tetraethyl ammonium bromide, dihydroxy ethyl stearyl amine, 2-heptadecenyl-hydroxyethyl imidazoline, lauryl dimethyl benzyl ammonium chloride, cetylpyridinium chloride, stearamid methyl pyridium chloride, diaryl dimethyl ammonium chloride polymer, diaryl amine polymer, and monoaryl amine polymer.

More preferably, there are used triethanol amine, triisopropanol amine, 2-amino-2-ethyl-1,3-propanediol, ethanol amine, propane diamine, and propyl amine as the organic amine compound.

Among these aggregating agents, polyvalent metal salts, such as Ca(NO₃), Mg(NO₃), Al(OH₃), a polyaluminum chloride, and the like are preferable.

The aggregating agents may be used alone or a two or more kinds of the aggregating agents may be mixed and used. The content of the aggregating agent is preferably 0.01% by mass to 30% by mass, more preferably 0.1% by mass to 15% by mass, and further preferably 1% by mass to 15% by mass.

Preferably, a releasing agent is contained in the ink receptive particles in the embodiments of the invention. It is hence possible to transfer or fix the ink receptive particles onto the recording medium in a manner of oilless. The releasing agent may be contained in the liquid absorbing resin, or the releasing agent particles may be contained by composite it together with particles of liquid absorbing resin.

Examples of such releasing agent include low molecular polyolefins such as polyethylene, polypropylene, polybutene, or the like; silicones having softening point by heating; fatty acid amides such as oleic amide, erucic amide, ricinoleic amide, stearic amide, or the like; vegetable wax such as carnauba wax, rice wax, candelilla wax, Japan wax, jojoba oil, or the like; animal wax such as beeswax, or the like; mineral or petroleum wax such as montan wax, ozokerite, ceresin, paraffin wax, microcrystalline wax, Fischer-Tropsch wax, or the like; and modifications thereof. Among them, crystalline compound is preferred.

External additives may be also added to the ink receptive particles in the embodiments of the invention. By adding the external additives, ink receptive particles are provided with powder fluidity, charging and conductive control, liquid absorbing control, and the like. Examples of the external additives include inorganic particles (colorless, pale color or white particles, for example, colloidal silica, alumina, calcium carbonate, zinc oxide, titanium oxide, tin oxide, cerium oxide, carbon black, or the like), resin particles (vinyl resin, polyester, silicone particles, or the like), and the like. Particles of these external additives may be either hydrophobic or hydrophilic, and may contain specific functional groups (for example, amino group or fluorine system) on the surface by treating the surface of the particles with a coupling agent (for example, silane coupling agent). Particle size of the external additives is preferably 5 nm to 100 nm, or more preferably 10 to 50 nm as expressed by volume average particle diameter.

Such ink receptive particles 16 are secondary particles that are aggregated weakly porous particles 16F capable of absorbing and retaining ink droplets 20A, and resin particles 16E having weak ink absorbing and fixing property, and have gaps 16G between the porous particles 16F and resin particles.

For a method of forming a particle layer 16A by the ink receptive particles 16 is a method that the ink receptive particles 16 are charged and the charged particles are supplied onto the surface of intermediate transfer body 12 by electric field, that is, xerographic method, charging property is required in the ink receptive particles 16. Accordingly, a charging control agent for toner may be internally added to the ink receptive particles 16. Further, in order to fix (trap) a coloring material (particularly pigment) in ink on the surface of porous particles and fixing particles 16E (primary particles), pigment and water-soluble polymer are preferred to be insoluble so as to react with ink receptive particles.

Further, the ink receptive particles 16 have a function of fixing the image when transferred or after transferred on the recording medium 8. For the purpose of fixing, transfer and fixing is carried out by pressure or heat, or pressure and heat using a transfer fixing device 22. In addition, in order to obtain color formation of ink after forming an image (in order to visually recognize the image through a layer 16C formed on an image layer 16B), the ink receptive particles 16 must be transparent at least after fixing.

<Intermediate Transfer Body>

The intermediate transfer body 12 on which the ink receptive particle layer is formed may be either belt as in the first to third embodiments, or cylindrical (drum) as in the tenth to twelfth embodiments. To supply and hold ink receptive particles on the surface of intermediate transfer body by an electrostatic force, the outer circumferential surface of the intermediate transfer body must have particle holding property of semiconductive or insulating properties. As electric characteristics for the surface of the intermediate transfer body, it is required to use a material having surface resistance of 10E10 to 14 ohms/square and volume resistivity of 10E9 to 13 ohm-cm in the case of the semiconductive property, and surface resistance of 10E14 ohms/square and volume resistivity of 10E13 ohm-cm in the case of the insulating property.

In the case of belt shape, the base material is not particularly limited as far as it is capable of rotating and driving a belt in the apparatus and has the mechanical strength needed to withstand the rotating and driving, and it has the heat resistance needed to withstand heat when heat is used in transfer/fixing. Specific examples of the substrate are polyimide, polyamide imide, aramid resin, polyethylene terephthalate, polyester, polyether sulfone, and stainless steel.

In the case of drum shape, the base material includes aluminum or stainless steel or the like.

To enhance transfer efficiency of the ink receptive particles 16 (for efficient transfer from intermediate transfer body 12 to recording medium 8), preferably, a releasing layer 14A is formed on the surface of intermediate transfer body 12. The releasing layer 14A may be formed either as surface (material) of the intermediate transfer body 12, or the releasing layer 14A may be formed on the surface of the intermediate transfer body 12 according to the manner of on-process by adding externally.

That is, when the surface of intermediate transfer body 12 is a releasing layer 14A, it is preferred to use fluorine based resins such as tetrafluoroethylene-ethylene copolymer, polyvinylidene fluoride, tetrafluoroethylene-perfluoroalkyl vinyl ether copolymer, tetrafluoroethylene-hexafluoropropylene copolymer, or the like, or elastic materials such as silicone rubber, fluorosilicone rubber, or phenyl silicone rubber.

When forming the releasing layer 14A by external addition, an aluminum of which surface is anodized is used in the case of drum shape, or the same base materials as those for the belt is used in the case of belt shape, or when an elastic material is formed (for either drum shape or belt shape), silicone rubber, fluorosilicone rubber, phenyl silicone rubber, fluororubber, chloroprene rubber, nitrile rubber, ethylene propylene rubber, styrene rubber, isoprene rubber, butadiene rubber, ethylene propylene butadiene rubber, and nitrile butadiene rubber.

In order to apply heating system by electromagnetic induction to the fixing process in the transfer fixing device 22, a heat generating layer may be formed on the intermediate transfer body 12, not on the transfer fixing device 22. The heat generating layer is made of a metal causing electromagnetic induction action. For example, nickel, iron, copper, aluminum or chromium may be used selectively.

<Particle Supply Process>

A process for forming ink receptive particle layer 16A of the ink receptive particles 16 will be explained hereinafter, but it can be also applied to a process of forming a protective particle layer 15A of protective particles 15.

On the surface of the protective particle layer 15A, an ink receptive particle layer 16A of ink receptive particles 16 is formed. At this time, as the method of forming an ink receptive particle layer 16A of the ink receptive particles 16, a general method of supplying an electrophotographic toner on a phosphor. That is, a charge is supplied in advance on the surface of intermediate transfer body 12 by general charging for an electrophotographic method (charging by a charging device 28 or the like). The ink receptive particles 16 are frictionally charged so as to make a counter charge to the charge on the surface of the intermediate transfer body 12 (one-component frictional charging method or two-component method).

Ink receptive particles 16 held on the supply roll 18A in FIG. 2A, FIG. 5A or FIG. 8A form an electric field together with the surface of intermediate transfer body 12, and are moved/supplied onto the intermediate transfer body 12 and held thereon by an electrostatic force. At this time, by the thickness of image layer 16B formed on the particle layer 16A of the ink receptive particles 16 (depending on an amount of the ink to be applied), the thickness of particle layer 16A of the ink receptive particles 16 can be also controlled. The charging amount of the ink receptive particles 16 is preferred to be in a range of 5 μc/g to 50 μc/g.

A particle supply process corresponding to one-component development system will be explained below.

The ink receptive particles 16 are supplied on a developing roll 18A, and charged by a charging blade 18B while the thickness of particle layer is regulated.

The charging blade 18B has a function of regulating the layer thickness of the ink receptive particles 16 on the surface of the supply roll 18A, and can change the layer thickness of the ink receptive particles 16 on the surface of the supply roll 18A by varying the pressure on the supply roll 18A. By controlling the layer thickness of the ink receptive particles 16 on the surface of the supply roll 18A to substantially one layer, the layer thickness of the ink receptive particles 16 formed on the surface of the intermediate transfer body 12 can be formed in substantially one layer. By controlling the pressing force on the charging blade 18B to be low, the layer thickness of the ink receptive particles 16 formed on the surface of the supply roll 18A can be increased, and the thickness of particle layer 16A of the ink receptive particles 16 formed on the surface of the intermediate transfer body 12 can be increased.

In other method, when the peripheral speed of intermediate transfer body 12 and supply roll 18A forming approximately one layer of particles on the surface of intermediate transfer body 12 to be 1, by increasing the peripheral speed of supply roll 18A, the number of ink receptive particles 16 supplied on the intermediate transfer body 12 can be increased, and it can be controlled so as to increase the thickness of particle layer 16A on the intermediate transfer body 12. Further, the layer thickness can be regulated by combining the above methods. In this configuration, for example, the ink receptive particles 16 are charged negatively, and the surface of intermediate transfer body 12 is charged positively.

By thus controlling the layer thickness of ink receptive particle layer 16A, consumption of ink receptive particle layer 16A is suppressed, and a pattern of which the surface consistently covered with a protective layer (in the second embodiment, a protective layer composed of ink receptive particle layer 16A and protective particle layer 15A) may be formed.

As the charging roll 18 in the charging device, it is possible to use a roll of 10 to 25 mm in diameter, having an elastic layer dispersed with a conductive material on the outer surface of bar or pipe member which is made of aluminum, stainless steel or the like, and having volume resistivity adjusted to approximately 10E6 to 10E8 ohm-cm.

The elastic layer includes resin material such as urethane resin, thermoplastic elastomer, epichlorhydrine rubber, ethylene-propylene-diene copolymer rubber, silicon system rubber, acrylonitrile-butadiene copolymer rubber, or polynorbornene rubber, and these resin materials may be used alone or a mixture of two or more resin materials may be used. A preferred material is a foamed urethane resin.

The foamed urethane resin is preferably a resin having closed cell structure formed by mixing and dispersing a hollow body such as hollow glass beads or microcapsules of thermal expansion type in a urethane resin. Such foamed urethane resin has a low hardness elasticity preferred for charging device, and also has a high contact stability on conveying belt, and is excellent in nip forming property.

Further, the surface of elastic layer may be coated with a water repellent skin layer of 5 to 100 μm in thickness, and it is effective for suppressing characteristic changes (changes in resistance value) due to humidity changes in the apparatus or sticking of ink mist to the charging layer surface.

A DC power source is connected to the charging device 28, and a driven roll 31 is electrically connected to the frame ground. The charging device 28 is driven while the intermediate transfer body 12 is placed between the charging device 28 and the driven roll 31. At the pressing position, since a specified potential difference is generated between the charging device 28 and the grounded driven roll 31, an electrical charge can be applied.

<Marking Process>

Ink droplets 20A are ejected from the ink jet recording head 20 based on an image signal, on the layer (particle layer 16A) of ink receptive particles 16 formed on the surface of intermediate transfer body 12 (particle layer 16A), and an image is formed. Ink droplets 20A ejected from the ink jet recording head 20 are implanted in the particle layer 16A of the ink receptive particles 16, and ink droplets 20A are quickly absorbed in the gaps 16G formed between the ink receptive particles 16, and the solvent is sequentially absorbed in the voids of porous particles 16F and fixing particles 16E, and the pigment (coloring material) is trapped on the surface of primary particles (porous particles 16F, fixing particles 16E) forming the ink receptive particles 16.

In this case, preferably, it is desired to trap plural pigments near the surface of particle layer 16A of ink receptive particles 16. This is realized when gaps between the primary particles composing secondary particles have filter effects to trap the pigment near the surface of particle layer 16A, and also trap and fix on the surface of primary particles.

To trap the pigment securely near the surface of particle layer 16A and on the surface of primary particles, the ink may react with ink receptive particles 16, and hence, the pigment may be quickly made insoluble (aggregated). Specifically, this reaction may be realized by reaction between ink and polyhydric metal salt, or pH reaction type.

To write an image at high speed, a line type ink jet recording head (FWA) having a width corresponding to a paper width is preferred, however by using a conventional scan type ink jet recording head, images may be formed sequentially on the particle layer formed on the intermediate transfer body. The ink ejecting unit of ink jet recording head 20 is not particularly limited as far as it is a unit capable of ejecting ink, such as piezoelectric element drive type, or heater element drive type, or the like. The ink itself may be ink using conventional dyes as a coloring material, however pigment ink is preferable.

When the ink receptive particles 16 react with the ink, the ink receptive particles 16 are treated with an aqueous solution containing a polyhydric metal salt which has effects of aggregating the pigment by reacting with ink, and dried before use.

Specific examples of polyhydric metal salt include aluminum chloride, aluminum bromide, aluminum sulfide, aluminum nitrate, barium chloride, barium bromide, barium iodide, barium oxide, barium nitrate, barium thiocyanate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, zinc acetate, and other compounds.

When the ink receptive particles 16 react with the ink, they may be treated with an aqueous solution containing an organic acid which has an effect on the aggregation of pigment by reacting with the ink, and dried before use.

Preferred examples of organic acid include citric acid, glycine, glutamic acid, succinic acid, tartaric acid, phthalic acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or derivatives or salts of these compounds. More preferred examples are pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or derivatives or salts of these compounds. Still more preferred examples are pyrrolidone carboxylic acid, pyrone carboxylic acid, furan carboxylic acid, coumaric acid, or derivatives or salts of these compounds.

<Ink>

The coloring material of ink used in reaction may be either dye or pigment, however pigment is preferred. Compared with dye, pigment is more likely to be aggregated at the time of reaction. Among pigments, a pigment dispersed with a high molecular dispersant, a self-dispersable pigment, or a pigment coated with resin are preferred.

A preferred ink in the ink set for ink jet in the embodiments of the invention is ink containing a resin (water-soluble high polymer, etc.) having a carboxylic group which has an effect on the aggregation of pigment by reacting with polyhydric metal salt or organic acid. For example:

(Black Ink)

—Composition—

Mogul L (manufactured by Cabot Corporation) (without pigment/surface functional group), 4% by mass

Styrene-acrylic acid-sodium acrylate copolymer: 0.6% by mass

Diethylene glycol: 15% by mass

Diglycerin ethylene oxide adduct: 5% by mass

Polyoxyethylene-2-ethylhexyl ether: 0.75% by mass

Ion exchange water: balance

The pH of this liquid is 8.2, volume-average particle size is 120 nm, surface tension is 32 mN/m, and viscosity is 3.3 mPa·s.

(Cyan Ink)

—Composition—

C.I. Pigment Blue 15:3: 4% by mass

Styrene-acrylic acid-sodium acrylate copolymer: 0.6% by mass

Diethylene glycol: 20% by mass

Glycerin: 5% by mass

Acetylene glycol ethylene oxide adduct: 1% by mass

Ion exchange water: balance

The pH of this liquid is 8.8, volume-average particle size is 92 nm, surface tension is 31 mN/m, and viscosity is 3.1 mPa·s.

(Magenta Ink)

—Composition—

C.I. Pigment Red 122: 4% by mass

Styrene-acrylic acid-sodium acrylate copolymer: 0.75% by mass

Diethylene glycol: 20% by mass

Glycerin: 5% by mass

Acetylene glycol ethylene oxide adduct: 1% by mass

Ion exchange water: balance

The pH of this liquid is 8.6, volume-average particle size is 106 nm, surface tension is 31 mN/m, and viscosity is 3.2 mPa·s.

(Yellow Ink)

—Composition—

C.I. Pigment Yellow 128: 4% by mass

Styrene-acrylic acid-sodium acrylate copolymer: 0.6% by mass

Diethylene glycol: 20% by mass

Glycerin: 5% by mass

Acetylene glycol ethylene oxide adduct: 1% by mass

Ion exchange water: balance

The pH of this liquid is 8.7, volume-average particle size is 115 nm, surface tension is 31 mN/m, and viscosity is 3.2 mPa·s.

<Transfer Process>

The ink receptive particle layer 16A (in the embodiments including a protective layer forming unit, ink receptive particle layer 16A and protective particle layer 15A) which receives ink drops 20A and an ink image layer 16B is formed is transferred and fixed on the recording medium 8, and therefore, an image is formed on the recording medium 8. The transfer and fixing may be done in separate processes, however the transfer and the fixing is preferably done at the same time. The fixing may be effected by any one of heating or pressing methods of the ink receptive particle layer 16A (in the embodiments including protective layer forming unit, ink receptive particle layer 16A and protective particle layer 15A), or by using both method of heating and pressing methods, or preferably by heating and pressing at the same time.

In the method conducting the heating/pressing, for example, the heating and fixing device (fuser) for electrophotography as shown in FIG. 15B, FIG. 16B and FIG. 17B can be applied. By controlling heating/pressing, the surface properties of ink receptive particle layer 16A can be controlled, and the degree of gloss can be controlled. After heating/pressing, when peeling the recording medium 8 on which the ink receptive particle layer 16A (in the embodiments including protective layer forming unit, ink receptive particle layer 16A and protective particle layer 15A) is transferred from the intermediate transfer body 12, it may be peeled off after cooling of the ink receptive particle layer 16A (in the embodiments containing protective layer forming unit, ink receptive particle layer 16A and protective particle layer 15A). The cooling method includes natural cooling and forced cooling such as air-cooling. In these processes, the intermediate transfer body 12 is preferred to be of belt shape.

The ink image is formed on the surface layer of ink receptive particles 16 formed on the intermediate transfer body 12 (the pigment is trapped near the surface of ink receptive particle layer 16A), and transferred on the recording medium 8, and therefore, the ink image layer 16B is formed so as to be protected by the particle layer 16C (in the embodiments containing protective layer forming unit, particle layer 16C and protective particle layer 15C) composed of ink receptive particles 16. That is, since the pigment (coloring material) is not present on the outmost layer transferred on the recording medium 8, effects of image disturbance by rubbing or the like can be prevented.

The ink solvent received/held in the layer of ink receptive particles 16 is held in the layer of ink receptive particles 16 after transfer and fixing, and removed by natural drying as the same in drying of ink solvent in ordinary water-based ink jet recording.

<Releasing Layer>

To enhance the transfer efficiency, before supplying ink receptive particles 16, a process may be provided for forming a releasing layer 14A such as silicone oil or the like on the surface of intermediate transfer body 12.

The releasing layer is composed of silicone oil, modified silicone oil, fluorine based oil, hydrocarbon based oil, mineral oil, vegetable oil, polyalkylene glycol oil, alkylene glycol ether, alkane diol, fused wax, or the like.

Material of elastic body includes silicone rubber, fluororubber, or the like. When using silicone rubber, if silicone oil is used as a lubricant, the silicone rubber is swollen, and to prevent the swollen of the silicone rubber, it is preferred to provide the surface of silicone rubber with a coating layer of fluorine resin or fluorine rubber.

Supply method of releasing layer 14 includes a method of forming a releasing layer 14A by furnishing an oil tank, supplying oil into an oil application member, and supplying oil on the surface of intermediate transfer body 12 by the application member, and a method of forming a releasing layer 14A on the surface of intermediate transfer body 12 by an applied member impregnated with oil.

<Cleaning Process>

To allow the repetitive use by refreshing the surface of intermediate transfer body 12, a process of cleaning the surface of intermediate transfer body 12 by a cleaning device 24 is needed. The cleaning device 24 consists of a cleaning part and a recovery part for conveying particles (not shown), and by the cleaning process, the ink receptive particles 16 (residual particles 16D) remaining on the surface of intermediate transfer body 12, and deposits sticking to the surface of intermediate transfer body 12 such as foreign matter (paper dust or the like of recording medium 8) other than particles can be removed. The collected residual particles 16D may be recycled.

<Neutrallizing Process>

Depending on the conditions of temperature or humidity, the surface resistance of intermediate transfer body 12 may be inappropriate value. When the surface of intermediate transfer body 12 is at high resistance, during supply of particles is carried out repeatedly, an electric charge may be accumulated on the surface of the intermediate transfer body 12 to increase the potential, and adverse effects on formation of particle layer may occur.

Before forming the releasing layer 14A, the surface of the intermediate transfer body 12 may be neutralized by using a neutralization apparatus 29. As a result, the electric charge accumulated on the surface of the intermediate transfer body 12 is removed, and effects on formation of ink receptive particle layer 16A can be suppressed.

<Other Embodiments>

In the foregoing embodiments, ink droplets 20A are selectively ejected from the ink jet recording heads 20 in black, yellow, magenta, and cyan colors on the basis of image data, and a full-color image is recorded on the recording medium 8. However, the invention is not limited to the recording of characters or image on recording medium. That is, the liquid droplet applying apparatus of the invention can be applied generally in liquid droplet ejection (spraying) apparatuses used industrially.

For example, the recording material of liquid droplets to be ejected is not limited to coloring material such as pigment or dye. For example, the invention may be applied to recording material for emitting fluorescent light by ultraviolet radiation. It may be also applied to magnetic matter (powder).

Hereinafter, particularly preferable modes of the invention are listed. However, the invention is not necessarily limited to these modes. Some embodiments of the invention are outlined below.

(1) A pattern forming method comprising:

forming a liquid receptive particle layer on an intermediate transfer body by using liquid receptive particles capable of receiving a recording liquid containing recording material; applying liquid droplets of the recording liquid at specified positions of the liquid receptive particle layer on the basis of specified data, trapping the recording material near the surface of the liquid receptive particle layer on the intermediate transfer body, and forming a pattern of the recording material near the surface of the liquid receptive particle layer; and peeling the liquid receptive particle layer containing the recording liquid from the intermediate transfer body and transferring the liquid receptive particle layer onto a transfer object so that the pattern is placed between the transfer object and the liquid receptive particle layer.

(2) The pattern forming method of (1), wherein the particle layer forming uses the liquid receptive particles that comprise composite particles having resin particles and inorganic particles, and gaps therebetween, wherein the resin particles show a fixing property by absorbing a solvent or dispersion medium of the recording liquid, the inorganic particles have pores, and the pores are capable of receiving the solvent or dispersion medium therein.

(3) The pattern forming method of (1) or (2), wherein the liquid receptive particle layer forming comprises forming a plurality of stacked layers of liquid receptive particles.

(4) The pattern forming method of (3), wherein the particle layer forming comprises forming a liquid receptive particle layer in a specified thickness on the basis of the specified data.

(5) The pattern forming method of any one of (1) to (4), wherein the peeling and transferring of the liquid receptive layer includes fixing the liquid receptive particle layer on the transfer object by pressing or heating the liquid receptive particle layer.

(6) The pattern forming method of any one of (1) to (5), further comprising forming a releasing layer on the surface of the intermediate transfer body,

wherein the particle layer forming forms the liquid receptive particle layer on the releasing layer.

(7) The pattern forming method of any one of (1) to (6), wherein the peeling and transferring includes transferring the liquid receptive particle layer holding a solvent or dispersion medium of the recording liquid on the transfer object.

(8) A pattern forming apparatus comprising: an intermediate transfer body; a particle supply unit for forming a liquid receptive particle layer of a specified layer thickness by supplying liquid receptive particles, capable of receiving a recording liquid containing recording material and also capable of trapping the recording material at the surface thereof, onto the intermediate transfer body; a liquid droplet ejection unit for ejecting liquid droplets of the recording liquid onto the liquid receptive particle layer on the basis of specified data, and forming a pattern of the recording material near the surface of the liquid receptive particle layer; and a transferring unit, for transferring the liquid receptive particle layer containing the recording liquid onto a transfer object so that the pattern is placed between the transfer object and the liquid receptive particle layer.

(9) The pattern forming apparatus of (8), wherein the particle supply unit supplies onto the intermediate transfer body the liquid receptive particles that comprise composite particles having resin particles and inorganic particles, and gaps therebetween, wherein the resin particles show a fixing property by absorbing a solvent or dispersion medium of the recording liquid, the inorganic particles have pores, and the pores are capable of receiving the solvent or dispersion medium therein.

(10) The pattern forming apparatus of (8) or (9), wherein the particle supply unit forms the liquid receptive particle layer of a thickness that does not let the recording material, contained in the recording liquid applied according to the specified data, reach the reverse side of the liquid receptive particle layer.

(11) The pattern forming apparatus of any one of (8) to (10), further comprising a releasing layer forming unit, for forming a releasing layer on the surface of the intermediate transfer body, wherein the particle supply unit forms the liquid receptive particle layer on the releasing layer.

(12) A pattern forming method comprising forming a protective layer on an intermediate transfer body, forming on the protective layer formed on the intermediate transfer body, the liquid receptive particles layer by using liquid receptive particles capable of receiving a recording liquid containing a recording material, applying liquid droplets of the recording liquid at specified position of the liquid receptive particle layer on the basis of specified data, trapping the recording material on the liquid receptive particle layer, and forming a pattern of the recording material on the liquid receptive particle layer, and peeling the protective layer and the liquid receptive particle layer containing the recording liquid from the intermediate transfer body so that the protective layer may be formed on the outermost surface, and transferring on a transfer object.

(13) The pattern forming method of (12), wherein the protective layer does not receive the recording liquid containing the recording material.

(14) A pattern forming apparatus comprising: an intermediate transfer body;

a protective layer forming unit for forming a protective layer on the intermediate transfer body; a particle supplying unit for supplying liquid receptive particles, capable of receiving a recording liquid containing a recording material and also capable of trapping the recording material at the surface thereof, onto the intermediate transfer body and forming a liquid receptive particle layer of a specified layer thickness; a liquid droplet ejection unit for ejecting liquid droplets of the recording liquid onto the liquid receptive particle layer on the basis of specified data, and forming a pattern of the recording material on the liquid receptive particle layer; and a transferring unit for transferring the protective layer and the liquid receptive particle layer containing the recording liquid onto a transfer object so that the protective layer is formed on the outermost front surface.

(15) The pattern forming apparatus of (14), wherein the protective layer does not receive the recording liquid containing the recording material.

(16) The pattern forming apparatus of (14) or (15), wherein the liquid droplet ejection unit comprises applying liquid droplets of the recording liquid onto the liquid receptive particles layer, trapping the recording material near the surface of the liquid receptive particle layer, and forming a pattern of the recording material near the surface of the liquid receptive particle layer.

(17) The pattern forming apparatus of any one of (14) to (16), wherein the liquid receptive particles are composite particles having resin particles and inorganic particles, and gaps therebetween, wherein the resin particles show a fixing property by absorbing a solvent or dispersion medium of the recording liquid, the inorganic particles have pores, and the pores are capable of receiving the solvent or dispersion medium therein.

(18) The pattern forming apparatus of any one of (14) or (17), wherein the particle supply unit forms the liquid receptive particle layer of a thickness that does not let the recording material, contained in the recording liquid applied according to the specified data, reach the reverse side of the liquid receptive particle layer.

(19) The pattern forming apparatus of any one of (14) to (18), further comprising a releasing layer forming unit at the upstream side of the protective layer forming unit, for forming a releasing layer on the surface of the intermediate transfer body.

(20) The pattern forming apparatus of any one of (14) to (19), wherein the liquid receptive particle layer forming comprises forming a plurality of stacked layers of liquid receptive particles.

(21) The pattern forming apparatus of any one of (14) to (20), wherein the transferring unit includes a fixing unit for fixing the protective layer and liquid receptive particles layer on the transfer object by pressing or heating.

(22) The pattern forming apparatus of any one of (14) to (21), wherein the transferring unit includes transferring the liquid receptive particle layer holding a solvent or dispersion medium of the recording liquid on the transfer object.

(23) A pattern forming method comprising forming a liquid receptive particle layer on an intermediate transfer body by using liquid receptive particles capable of receiving a recording liquid containing a recording material, applying liquid droplets of the recording liquid at specified position of the liquid receptive particle layer on the basis of specified data, trapping the recording material near the surface of the liquid receptive particle layer on the intermediate transfer body, and forming a pattern of the recording material near the surface of the liquid receptive particle layer, removing the liquid receptive particles in a region not forming the pattern, and peeling the liquid receptive particle layer containing the recording liquid from the intermediate transfer body so that the pattern is placed between a transfer object and the liquid receptive particle layer, and transferring on the transfer object.

(24) A pattern forming apparatus comprising: an intermediate transfer body;

a particle supplying unit for supplying liquid receptive particle, capable of receiving a recording liquid containing a recording material and also capable of trapping the recording material at the surfaces thereof, onto the intermediate transfer body, and forming a liquid receptive particle layer of a specified layer thickness; a liquid droplet ejection unit for applying liquid droplets of the recording liquid onto the liquid receptive particle layer on the basis of specified data, and forming a pattern of the recording material near the surface of the liquid receptive particle layer; a removing unit for removing the liquid receptive particles in a region not forming the pattern; and a transferring unit for transferring the liquid receptive particle layer containing the recording liquid onto a transfer object so that the pattern is placed between the transfer object and the liquid receptive particle layer.

(25) The pattern forming apparatus of (24), wherein the removing unit is selectable unit whether or not removing is carried out.

(26) The pattern forming apparatus of (24) or (25), wherein liquid receptive particles removed by the removing unit are returned to the particle supply unit, and the removed liquid receptive particles are recycled.

(27) The pattern forming apparatus of any one of (24) to (26), wherein the removing unit comprises: a removing force generating unit, for generating a removing force smaller than the adhesion force of the liquid receptive particles to the intermediate transfer body in the region forming the pattern, and larger than the adhesion force of the liquid receptive particles to the intermediate transfer body in the region not forming the pattern.

(28) The pattern forming apparatus of (27), wherein the removing force generating unit is electrostatic force generating unit.

(29) The pattern forming apparatus of (28), wherein the removing force generating unit is a blowing unit for blowing air to the liquid receptive resin layer.

(30) The pattern forming apparatus of any one of (24) to (29), wherein at the upstream side of the removing force generating unit, a provisional fixing unit for provisionally fixing the liquid receptive particle layer in the region that a pattern has been formed to an extent to be transferred onto the transfer object by the peeling and transferring unit.

(31) The pattern forming apparatus of (30), wherein the provisional fixing unit includes provisionally fixing the region that the pattern has been formed, by elevating the temperature in the region that the pattern has been formed.

(32) The pattern forming apparatus of (31), wherein the provisional fixing unit is an infrared irradiating unit for illuminating infrared ray to the liquid receptive particle layer.

(33) The pattern forming apparatus of any one of (24) to (32), the liquid receptive particles that comprise composite particles having resin particles and inorganic particles, and gaps therebetween are supplied onto the intermediate transfer body, wherein the resin particles show a fixing property by absorbing a solvent or dispersion medium of the recording liquid, the inorganic particles have pores, and the pores are capable of receiving the solvent or dispersion medium therein.

(34) The pattern forming apparatus of any one of (24) to (33), wherein the particle supply unit forms the liquid receptive particle layer of a thickness that does not let the recording material, contained in the recording liquid applied according to the specified data, reach the reverse side of the liquid receptive particle layer.

(35) The pattern forming apparatus of any one of (24) to (34), further comprising a releasing layer forming unit at the upstream side of the particle supply unit, for forming a releasing layer on the surface of the intermediate transfer body.

(36) The pattern forming apparatus of any one of (24) to (35), wherein the particle supply unit comprises forming a plurality of stacked layers of liquid receptive particles.

(37) The pattern forming apparatus of (36), wherein the particle supply unit comprises forming a liquid receptive particle layer in a specified thickness on the basis of the specified data.

(38) The pattern forming apparatus of any one of (24) to (37), wherein the transferring unit includes a fixing unit for fixing the protective layer and liquid receptive particles layer on the transfer object by pressing or heating.

(39) The pattern forming apparatus of any one of (24) to (38), wherein the transferring unit includes transferring the liquid receptive particle layer holding a solvent or dispersion medium of the recording liquid on the transfer object.

As explained herein, according to an embodiment of the invention, in the pattern forming method and pattern forming apparatus of the intermediate transfer system using the liquid droplet ejection method, regardless of the type of the recording medium, it is free from bleeding or disturbance of image due to undried liquid droplets in impermeable paper, in particular, and pattern fastness is excellent, and pattern forming method and pattern forming apparatus capable of high-speed recording can be realized.

All publications, patent applications, and technical standards mentioned in this specification are herein incorporated by reference to the extent as if each individual publication, patent application, or technical standard was specifically and individually indicated to be incorporated by reference.

What is claimed is:

1. A pattern forming method comprising:
forming a liquid receptive particle layer on an intermediate transfer body by using liquid receptive particles capable of receiving a recording liquid containing recording material;
applying liquid droplets of the recording liquid at specified positions of the liquid receptive particle layer on the basis of specified data, trapping the recording material near the surface of the liquid receptive particle layer on the intermediate transfer body, and forming a pattern of the recording material near the surface of the liquid receptive particle layer; and
peeling the liquid receptive particle layer containing the recording liquid from the intermediate transfer body and transferring the liquid receptive particle layer onto a transfer object so that the pattern is placed between the transfer object and the liquid receptive particle layer.

2. The pattern forming method of claim 1, wherein the particle layer forming uses the liquid receptive particles that comprise composite particles having resin particles and inorganic particles, and gaps therebetween, wherein
the resin particles show a fixing property by absorbing a solvent or dispersion medium of the recording liquid,
the inorganic particles have pores, and the pores are capable of receiving the solvent or dispersion medium therein.

3. The pattern forming method of claim 1, wherein the liquid receptive particle layer forming comprises forming a plurality of stacked layers of liquid receptive particles.

4. The pattern forming method of claim 1, wherein the peeling and transferring of the liquid receptive layer includes fixing the liquid receptive particle layer on the transfer object by pressing or heating the liquid receptive particle layer.

5. The pattern forming method of claim 1, further comprising forming a releasing layer on the surface of the intermediate transfer body,
wherein the particle layer forming forms the liquid receptive particle layer on the releasing layer.

6. A pattern forming apparatus comprising:
an intermediate transfer body;
a particle supply unit for forming a liquid receptive particle layer of a specified layer thickness by supplying liquid receptive particles, capable of receiving a recording liquid containing recording material and also capable of trapping the recording material at the surface thereof, onto the intermediate transfer body;
a liquid droplet ejection unit for ejecting liquid droplets of the recording liquid onto the liquid receptive particle layer on the basis of specified data, and forming a pattern of the recording material near the surface of the liquid receptive particle layer; and
a transferring unit, for transferring the liquid receptive particle layer containing the recording liquid onto a transfer object so that the pattern is placed between the transfer object and the liquid receptive particle layer.

7. The pattern forming apparatus of claim 6, wherein the particle supply unit supplies onto the intermediate transfer body the liquid receptive particles that comprise composite particles having resin particles and inorganic particles, and gaps therebetween, wherein
the resin particles show a fixing property by absorbing a solvent or dispersion medium of the recording liquid,
the inorganic particles have pores, and the pores are capable of receiving the solvent or dispersion medium therein.

8. The pattern forming apparatus of claim 6, wherein the particle supply unit forms the liquid receptive particle layer of a thickness that does not let the recording material, contained in the recording liquid applied according to the specified data, reach the reverse side of the liquid receptive particle layer.

9. The pattern forming apparatus of claim 6, further comprising a releasing layer forming unit, for forming a releasing layer on the surface of the intermediate transfer body,
wherein the particle supply unit forms the liquid receptive particle layer on the releasing layer.

10. A pattern forming apparatus comprising:
an intermediate transfer body;
a protective layer forming unit for forming a protective layer on the intermediate transfer body;
a particle supplying unit for supplying liquid receptive particles, capable of receiving a recording liquid containing a recording material and also capable of trapping the recording material at the surface thereof, onto the intermediate transfer body and forming a liquid receptive particle layer of a specified layer thickness;
a liquid droplet ejection unit for ejecting liquid droplets of the recording liquid onto the liquid receptive particle layer on the basis of specified data, and forming a pattern of the recording material on the liquid receptive particle layer; and
a transferring unit for transferring the protective layer and the liquid receptive particle layer containing the recording liquid onto a transfer object so that the protective layer is formed on the outermost front surface.

11. The pattern forming apparatus of claim 10, wherein the protective layer does not receive the recording liquid containing the recording material.

12. The pattern forming apparatus of claim 10, further comprising a releasing layer forming unit at the upstream side of the protective layer forming unit, for forming a releasing layer on the surface of the intermediate transfer body.

13. The pattern forming apparatus of claim 10, wherein the transferring unit includes a fixing unit for fixing the protective layer and liquid receptive particles layer on the transfer object by pressing or heating.

14. A pattern forming apparatus comprising:
an intermediate transfer body;
a particle supplying unit for supplying liquid receptive particle, capable of receiving a recording liquid containing a recording material and also capable of trapping the recording material at the surfaces thereof, onto the intermediate transfer body, and forming a liquid receptive particle layer of a specified layer thickness;
a liquid droplet ejection unit for applying liquid droplets of the recording liquid onto the liquid receptive particle layer on the basis of specified data, and forming a pattern of the recording material near the surface of the liquid receptive particle layer;
a removing unit for removing the liquid receptive particles in a region not forming the pattern; and
a transferring unit for transferring the liquid receptive particle layer containing the recording liquid onto a transfer object so that the pattern is placed between the transfer object and the liquid receptive particle layer.

15. The pattern forming apparatus of claim 14, wherein the removing unit is selectable unit whether or not removing is carried out.

16. The pattern forming apparatus of claim 15, wherein liquid receptive particles removed by the removing unit are returned to the particle supply unit, and the removed liquid receptive particles are recycled.

17. The pattern forming apparatus of claim 14, wherein the removing unit comprises:
a removing force generating unit, for generating a removing force smaller than the adhesion force of the liquid receptive particles to the intermediate transfer body in the region forming the pattern, and larger than the adhesion force of the liquid receptive particles to the intermediate transfer body in the region not forming the pattern.

18. The pattern forming apparatus of claim 14, further comprising a releasing layer forming unit at the upstream side of the particle supply unit, for forming a releasing layer on the surface of the intermediate transfer body.

19. The pattern forming apparatus of claim 14, wherein the transferring unit comprises a fixing unit for fixing the liquid receptive particle layer to the transfer object by pressing or heating the liquid receptive particle layer.
